(19) United States
(12) Patent Application Publication
(10) Pub. No.: US 2006/0053154 A1
(43) Pub. Date: Mar. 9, 2006

(54) Method and system for retrieving information based on manually-input keyword and automatically-selected keyword

(76) Inventor: Takashi Yano, Tokyo (JP)

Correspondence Address: HARNESS, DICKEY & PIERCE, P.L.C., P.O. BOX 8910, RESTON, VA, 20195, US

(21) Appl. No.: 11/202,356

(22) Filed: Aug. 12, 2005

(30) Foreign Application Priority Data
Sep. 9, 2004 (JP) 2004-262931

(51) Int. Cl. G06F 17/30

(52) U.S. Cl. 707/102

(57) ABSTRACT

A system for retrieving information includes: a first-keyword extracting unit that extracts a character string from a document displayed on a display as a first keyword; a second-keyword extracting unit that extracts a second keyword from a predetermined part of the document; an information retrieving unit that retrieves the information based on the first keyword and the second keyword; and an information displaying unit that displays the information retrieved on the display.

### CROSS-REFERENCE TO RELATED APPLICATIONS

The present document incorporates by reference the entire contents of Japanese priority document, 2004-262931 filed in Japan on Sep. 9, 2004.

### BACKGROUND OF THE INVENTION

1. Field of the Invention

The present invention relates to a technology for retrieving information using an input keyword manually input by a user and a keyword selected automatically by an information retrieval system based on the input keyword, to obtain an appropriate retrieve result and provide the retrieve result with appropriate advertising contents.

2. Description of the Related Art

The popularization of the Internet in recent years has enabled a network-connected computer to extract various types of information from a web server, and to provide the extracted information to the users all over the world easily and quickly.

For enabling the users to find necessary information, search engines have been provided, which collect in advance various types of information provided by Web servers around the world. When a user inputs a keyword (word), a search engine starts searching information including the keyword from the contents information, and display a list of results.

It is ideal if an appropriate search result is obtained by one keyword. However, one keyword can have different meanings according to the field or the context, and this is noticeable in the case of proper nouns and abbreviation.

For example, a term “Smart Taggs” is a name of a user interface technique of Microsoft Corporation in the field of information processing software, and is also a name of radio frequency identification (RF-ID) technique in the media field in the same information processing. Furthermore, “ATM” is an abbreviation of automatic teller machine (ATM) used in banks, “At the Money” in the finance field, or “Asynchronous Transfer Mode” in the communication field.

Thus, in the general search engine, one keyword is not sufficient, and to exclude unnecessary information and obtain appropriate search results, it is necessary to use about three keywords to perform AND search.

On the other hand, a banner advertisement displayed when a user accesses an intended Web page is convenient to find by chance an interesting item or what the user is looking for, but it is relatively difficult to find an appropriate banner advertisement, and hence, the advertising effect of the banner advertisement is decreasing recently. Therefore, advertisers of the banner advertisement try to display attractive contents, but it is not easy to understand users' state of mind and preferences precisely. Furthermore, since the banner advertisement is not real time, it does not have an impact on users.

To find a breakthrough in such a situation, an advertising search service has been recently used. In the advertising search service, advertisers decide unit price per one click for a keyword, the advertisement is displayed in order of high unit price, the amount obtained by multiplying the unit price by the number of clicks is charged to the advertiser, and a part of the charged amount is paid to the cooperative website on which the advertisement is inserted. The advertising search service is referred to as Pay Per Click (PPC) or Pay For Performance (PFP), and recently many search engines introduce this service in Japan, for ensuring profit.

The way of insertion of the advertisement is such that an advertisement of a company, which carries the keyword, is displayed in text in a link format like the general search result, above the search result by the search engine, separately from the general search result.

Since the advertising search service has a link in response to only a particular keyword specified by the user who performs the search, the click ratio for the advertisement becomes pretty high, as compared to the conventional banner advertisement, which has a link regardless of user's intention.

However, the keyword input by the user is not always a keyword, in which the user is highly interested. For example, such a situation can be considered that when a user reads an interesting document, the user uses the search service, because the user does not understand a term used in the translation of the document.

A technique for providing information interesting to the user is disclosed in Japanese Patent Application Laid-Open No. H11-296537. According to the technique, a word reflecting the preference of a user is automatically extracted from information such as a document file, which is irrelevant to the information search and stored in a terminal generally used by the user for information search, divided into relative types of words, and stored in a preference information storage unit.

When the user inputs a search keyword, an auxiliary keyword related to the search keyword is extracted from the preference information storage unit. User's usual action mode is, presumed by using an auxiliary keyword related to the action, and the search results by the search keyword are classified according to the presumed action mode and displayed.

Accordingly, even if the user is unfamiliar with setting of the keyword, efficient information search can be performed, reflecting user's preference.

In Japanese Patent Application Laid-Open No. H11-296537, however, when the specified search keyword is not always a keyword highly interesting to the user, the search result reflecting the user's preference cannot be obtained. Furthermore, in Japanese Patent Application Laid-Open No. H11-296537, in the case of an advertising search service, advertising contents reflecting the intention of an advertiser and highly interesting to users cannot always be provided.

In the advertising searching service, there is a case of obtaining the URL of a Web page browsed by the user, to reflect the interest and preference of the user. At this time, the entire information of the Web page can be seen from the obtained URL, and hence, there is a high possibility of privacy violation.

On the other hand, in the browser for performing display and operation of the Web page, it is general to operate only by a mouse. Therefore, if a keyword is input by keyboard input as in the conventional search engine, there are problems in that the user interface is inferior, and since the operation method is different, the workability is poor.

To solve the above problems, in Japanese Patent Application Laid-Open No. 2000-29906, comfortable operation environment is provided by specifying a word in a document displayed on a screen by the mouse operation or the like, to perform search by using the specified word as a keyword, and displaying the search result on the screen.

Methods for selecting a word in a document or a part of the document displayed on a screen include the following methods (see Japanese Patent Application Laid-Open No. 2000-29906):

(1) to select a word including a cursor position by single-clicking a left button of the mouse; and

(2) to extract the specified range as a word or a phrase by dragging while pressing the left button of the mouse.

There are various forms for display of processing menus and display spots, which are applied to the range selected in the above manner.

For the display operation of the menu, there are:

(1) a method of displaying a processing menu by operating the right button of the mouse, after selecting a word or a part of a document, and in this case, since other functions irrelevant to the system (copy, cut, or the like) are displayed together in the processing menu, it becomes difficult to see which is the function of the system with an increase in the processing functions; and

(2) a method of displaying a processing menu by displaying a special icon or the like near the selected word or part of the document and operating the right button of the mouse (if the mouse is operated in other spots, the selection has to be reset). In the processing menu, only the processing functions (for example, various services such as Web search, dictionary search, and translation) provided by the system can be displayed, and hence, even if the processing functions of the system increase, excellent operation environment can be provided.

For the display spot of the menu, there are:

(1) a method of displaying the menu as a pop-up menu near the selected word or part of the document, which can clarify the correspondence of the menu with the selected word or part of the document. However, the method has a problem in that the peripheral contents of the document are covered up; and

(2) a method of displaying the menu at a predetermined position on a display screen, for example, one of the four corners of the display screen. In this case, the peripheral contents of the selected word or document are not covered up.

### SUMMARY OF THE INVENTION

It is an object of the present invention to at least solve the problems in the conventional technology.

A system for retrieving information according to an aspect of the present invention includes: a first-keyword extracting unit that extracts a character string from a document displayed on a display as a first keyword; a command-menu displaying unit that displays a command menu for the first keyword on the display; a second-keyword extracting unit that extracts, when a command for retrieving the information is selected by a user from the command menu, a second keyword from a predetermined part of the document; an information retrieving unit that retrieves the information based on the first keyword and the second keyword; and an information displaying unit that displays the information retrieved on the display.

A system for retrieving information according to another aspect of the present invention includes: a first-keyword extracting unit that extracts a character string from a document displayed on a display as a first keyword; a command-menu displaying unit that displays a command menu for the first keyword on the display; a second-keyword extracting unit that extracts, when a command for retrieving,the information is selected by a user from the command menu, a second keyword from a predetermined part of the document; a keyword storing unit that stores the second keyword and a rank of the second keyword in a database; a third-keyword extracting unit that extracts at least one keyword having a highest rank from the database as a third keyword; an information retrieving unit that retrieves the information based on the first keyword and the third keyword; and an information displaying unit that displays the information retrieved on the display.

A system for retrieving information according to still another aspect of the present invention includes: a first-keyword extracting unit that extracts a character string from a document displayed on a display as a first keyword; a command-menu displaying unit that displays a command menu for the first keyword on the display; a keyword storing unit that stores the first keyword and a rank of the first keyword in a database; a second-keyword extracting unit that extracts at least one keyword having a highest rank from the database as a second keyword; an information retrieving unit that retrieves the information based on the first keyword and the second keyword; and an information displaying unit that displays the information retrieved on the display.

A client device according to still another aspect of the present invention, which is connected to a server for retrieving information via a network, includes: a first-keyword extracting unit that extracts a character string from a document displayed on a display as a first keyword; a command-menu displaying unit that displays a command menu for the first keyword on the display; a second-keyword extracting unit that extracts, when a command for retrieving the information is selected by a user from the command menu, a second keyword from a predetermined part of the document; a keyword sending unit that sends the second keyword to the server; an information receiving unit that receives the information retrieved by the server based on the first keyword and the second keyword; and an information displaying unit that displays the information received on the display.

A client device according to still another aspect of the present invention, which is connected to a server for retrieving information via a network, includes: a first-keyword extracting unit that extracts a character string from a document displayed on a display as a first keyword; a command-menu displaying unit that displays a command menu for the first keyword on the display; a second-keyword extracting unit that extracts, when a command for retrieving the information is selected by a user from the command menu, a second keyword from a predetermined part of the document; a keyword storing unit that stores the second keyword and a rank of the second keyword in a database; a third-keyword extracting unit that extracts at least one keyword having a highest rank from the database as a third keyword; a keyword sending unit that sends the first keyword and the second keyword to the server; an information receiving unit that receives the information retrieved by the server based on the first keyword and the third keyword; and an information displaying unit that displays the information received on the display.

A client device according to still another aspect of the present invention, which is connected to a server for retrieving information via a network, includes: a first-keyword extracting unit that extracts a character string from a document displayed on a display as a first keyword; a command-menu displaying unit that displays a command menu for the first keyword on the display; a keyword storing unit that stores the first keyword and a rank of the first keyword in a database; a second-keyword extracting unit that extracts at least one keyword having a highest rank from the database as a second keyword; a keyword sending unit that sends the first keyword and the second keyword to the server; an information receiving unit that receives the information retrieved by the server based on the first keyword and the second keyword; and an information displaying unit that displays the information received on the display.

A method of retrieving information according to still another aspect of the present invention includes: extracting a character string from a document displayed on a display as a first keyword; displaying a command menu for the first keyword on the display; extracting, when a command for retrieving the information is selected by a user from the command menu, a second keyword from a predetermined part of the document; retrieving the information based on the first keyword and the second keyword; and displaying the information retrieved on the display.

A method of retrieving information according to still another aspect of the present invention includes: extracting a character string from a document displayed on a display as a first keyword; displaying a command menu for the first keyword on the display; extracting, when a command for retrieving the information is selected by a user from the command menu, a second keyword from a predetermined part of the document; storing the second keyword and a rank of the second keyword in a database; extracting at least one keyword having a highest rank from the database as a third keyword; retrieving the information based on the first keyword and the third keyword; and displaying the information retrieved on the display.

A method of retrieving information according to still another aspect of the present invention includes: extracting a character string from a document displayed on a display as a first keyword; displaying a command menu for the first keyword on the display; storing the first keyword and a rank of the first keyword in a database; extracting at least one keyword having a highest rank from the database as a second keyword; retrieving the information based on the first keyword and the second keyword; and displaying the information retrieved on the display.

A computer-readable recording medium according to still another aspect of the present invention stores a computer program that causes a computer to execute the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of the functional configuration of an information search system according to a first embodiment of the present invention;

FIG. 2 is a block diagram of the functional configuration of a keyword extracting unit;

FIG. 3 is a flowchart for explaining the processing procedure of the first embodiment;

FIG. 4 is a block diagram of the functional configuration of the information search system according to a second embodiment of the present invention;

FIG. 5 is a flowchart for explaining the processing procedure of the second embodiment;

FIG. 6 is a block diagram of the functional configuration of the information search system according to a third embodiment of the present invention;

FIG. 7 is an example of a data configuration of a co-occurrence frequency user keyword database;

FIG. 8 is a flowchart for explaining the processing procedure according to the third embodiment;

FIG. 9 is a block diagram of the functional configuration of the information search system according to a fourth embodiment of the present invention;

FIG. 10 is a flowchart for explaining the processing procedure according to the fourth embodiment;

FIG. 11 is a block diagram of the functional configuration of an advertising search system according to a fifth embodiment of the present invention;

FIG. 12 is a dialog example for advertisement contents displaying the result of the advertising search;

FIG. 13 is a flowchart for explaining the processing procedure according to the fifth embodiment;

FIG. 14 is a block diagram of an embodiment of the present invention, including a service site for providing information search or advertising search service and user sites receiving the service;

FIG. 15 is a block diagram of the functional configuration of the advertising search system having a configuration such that extraction of an auxiliary keyword by the keyword extracting unit is performed in the user sites and the auxiliary keyword is transferred to the service site;

FIG. 16 is a block diagram of the functional configuration of the advertising search system having a configuration such that selection of the auxiliary keyword by a user keyword manager is performed by using the keyword extracted from a browsed document in the user sites and the auxiliary keyword is transferred to the service site;

FIG. 17 is a block diagram of the functional configuration of the advertising search system having a configuration such that extraction of a keyword by the keyword extracting unit is performed in the user sites and the keyword is transferred to the user keyword manager in the service site;

FIG. 18 is a block diagram of the functional configuration of the advertising search system having a configuration such that selection of the auxiliary keyword by the user keyword manager by using an input keyword is performed in the user sites and the auxiliary keyword is transferred to the service site;

FIG. 19 is a block diagram of the functional configuration of the advertising search system having a configuration such that input of the keyword is performed in the user sites and the input keyword is transferred to the user keyword manager in the service site;

FIG. 20 is a block diagram of the functional configuration when the keyword extracted by the keyword extracting unit is subjected to the processing by a transfer filter unit and the filtered keyword is transferred to the service site (first pattern);

FIG. 21 is a block diagram of the functional configuration when the keyword extracted by the keyword extracting unit is subjected to the processing by the transfer filter unit and the filtered keyword is transferred to the user keyword manager (second pattern);

FIG. 22 is a block diagram of the functional configuration when the auxiliary keyword obtained by the user keyword manager is subjected to the processing by the transfer filter unit and the filtered auxiliary keyword is transferred to the service site (third pattern);

FIG. 23 is a dialog example for displaying a list of keywords to be filtered to confirm whether these keywords can be transferred;

FIG. 24 is a dialog example that lists and displays the state of the keyword registered in a word table;

FIG. 25 is a dialog example when registering a transfer-prohibited document in a document identification (ID) table or editing the document;

FIG. 26 is a display example of the contents registered in the document ID table (a transfer-prohibited document ID table and a transfer-prohibited attribute table);

FIG. 27 is a dialog example when confirming the result of evaluation whether transfer of the browsed document is approved according to the document ID table;

FIG. 28 is a dialog example at the time of final confirmation whether the transfer of the keyword is approved; and

FIG. 29 is a display example of a word selected by operating a mouse and a pop-up menu.

### DETAILED DESCRIPTION OF THE PREFERRED EMBODIMENTS

Exemplary embodiments of the present invention will be explained below in detail with reference to the accompanying drawings.

An information search service in which a document associated with one keyword specified by a user is searched and the search result is provided to the user will be explained below as an example of the information search system. However, the present invention is not limited to the information search service. For example, the invention can be easily applied to a dictionary service in which not only terms used in a translation and examples are provided with respect to a word appeared in a document which the user is browsing, but also a document including the word is searched and provided, and a translation service for translating a part of the document which the user is browsing.

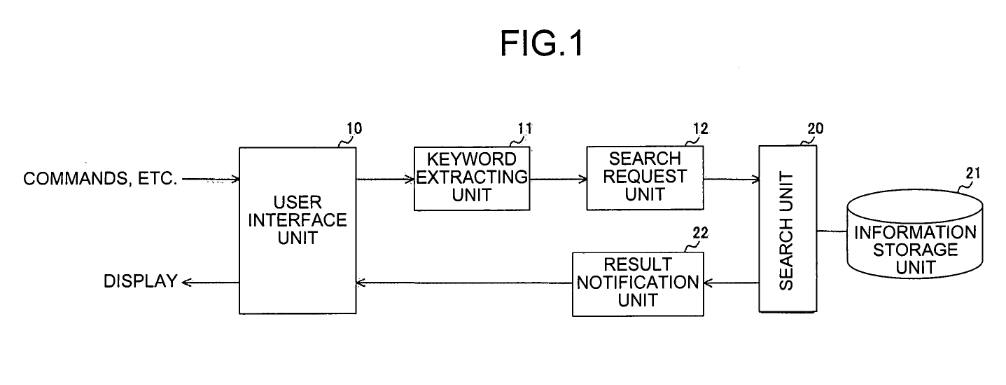

FIG. 1 is a block diagram of the functional configuration of the information search system according to a first embodiment of the present invention. The information search system includes a user interface (hereinafter, “user I/F”) unit 10, a keyword extracting unit 11, a search request unit 12, a search unit 20, an information storage unit 21, and a result notification unit 22.

The user I/F unit 10 inputs a word or a part of a document selected by a user by the mouse operation, while browsing the document, as a keyword. When a service is selected from a displayed menu, the user I/F unit 10 sends the input keyword to the search request unit 12, and also sends the browsed document and the input keyword to the keyword extracting unit 11. The mouse operation will be used for selecting a word or a part of the document in the explanation below, but the selection method is not limited thereto, and an input device including a button that can specify a position and allocate a function, such as a pen, is applicable likewise.

When having received the search result from the result notification unit 22, the user I/F unit 10 displays and outputs the received search result to a display unit, an output unit, and the like.

When shifting a cursor to the range of a word, which the user wishes to make a keyword, in the displayed document and single-clicking or double-clicking the left button of the mouse, a character string formed of the same kind of character type is cut out from around the character indicated by the cursor, referring to the character type and punctuation marks, and the character string matched with the word in a word dictionary is specified as a desired word (keyword).

Alternatively, the range is specified by dragging the mouse while pressing the left button of the mouse, to extract the word or a phrase in the specified range.

In either method above, the selected word or part of the document is displayed by highlighting or changing the color, so that the selected portion is recognizable.

When the processing is executed with respect to the selected portion, selecting a desired processing function from a menu bar or displaying the menu by the right button of the mouse, while putting the cursor on the selected portion, can be regarded as the most suitable method, which matches the operation method of the personal computer.

However, other functions (copy, cut, or the like) have been already set as the menu displayed by the right button, and are over-crowded. Therefore, if a series of services provided by the present invention is added to the menu displayed by the right button, it is difficult to distinguish the service of the present invention. Furthermore, according to the menu bar method, operation of cursor shift is required.

According to the present invention, therefore, a word or a part of a document is selected, and highlight-displayed or displayed by a different color, and transparent button is created so as to cover the character string in the selected portion. The user shifts the cursor to the selected portion where there is the transparent button, and clicks the left button or the right button. A menu is then displayed, in which only the various services provided by the present invention, such as Web search, dictionary search, translation, and information search (AND, OR) are listed.

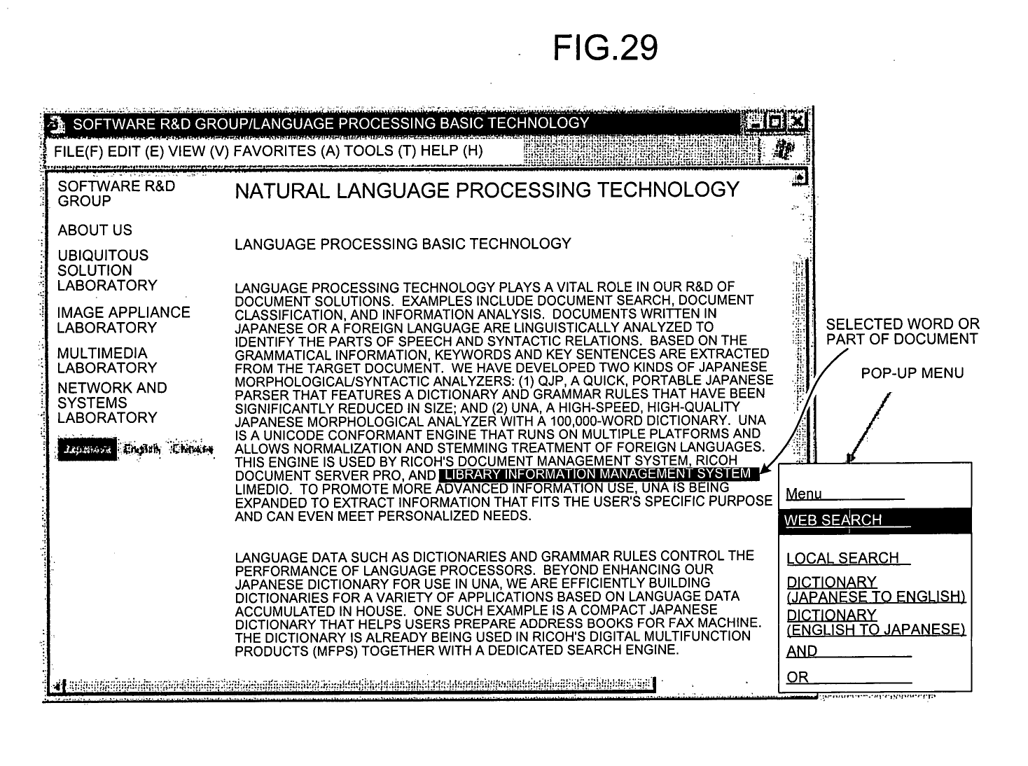

The menu is displayed as a pop-up menu near the selected word or part of the document (see FIG. 29), or displayed at one of the four corners, such as the right bottom of the display screen. In the case of the pop-up menu, the correspondence with the selected word or part of the document can be made clear, and on the other hand, when the menu is displayed at one of the four corners, such as the right bottom of the display screen, there is the effect that the vicinity of the selected word or part of the document is not covered up.

As the method of selecting a word in a displayed document or a part of the document, the cursor is shifted onto the word or the like to be selected and single- or double-clicking the third button of the mouse, or pressing and dragging the third button to select the-range to be selected. This method is the same as the button operation by the left button described above.

When selection is performed by the third button, the selected portion is highlighted or displayed by changing the color, and a menu in which only the various services provided by the present invention, such as Web search, dictionary search, translation, and information search (AND, OR) are listed is displayed. The user then selects a desired menu from the menus by the third button (either one of the left button and the right button).

Accordingly, the methods of (1) and (2) have excellent compatibility, since the difference from the conventional operation method of the personal computer is small. However, the method of (2) has a characteristic in that word selection and menu display can be performed in one operation, while in the method of (1), there are two stages of word selection and menu display.

The keyword extracting unit 11 transfers the keyword extracted from the browsed document transferred from the user I/F unit 10 to the search request unit 12 as the auxiliary keyword.

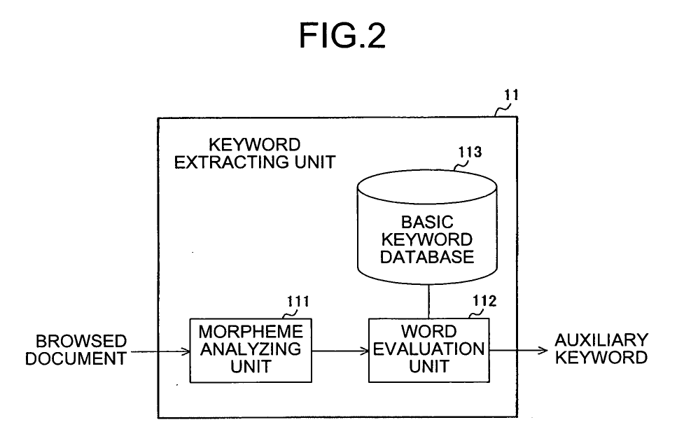

FIG. 2 is a block diagram of the functional configuration of the keyword extracting unit 11. In FIG. 2, the keyword extracting unit 11 includes a morpheme analyzing unit 111, a word evaluation unit 112, and a basic keyword database (hereinafter, database is abbreviated as “DB”) 113.

The keyword extracting unit 11 sets the range for extracting the keyword to anyone of:

(1) the sentence in the range near the word, when the input keyword is selected and specified by a word in the browsed document;

(2) the sentence in the browsed document in the range displayed in a window; and

(3) the whole browsed document,

which is predetermined to be used as the extraction range.

The sentence in one of the ranges described above in the browsed document is divided into the word strings with the part of speech by the morpheme analyzing unit 111, which is a well-known technique.

The basic keyword DB 113 holds the part of speech and importance for each word. As the importance, when words such as noun are used as the keyword, a large value is set, and a small value (for example, zero) is set to words other than noun and words, which are not useful as the keyword.

The word evaluation unit 112 refers to the basic keyword DB 113 and extracts the importance for the respective words divided by the morpheme analyzing unit 111, to arrange the importance in order of the degree of importance. Predetermined number of words (for example, three) are extracted from the one having the highest importance and designated as the keyword.

The keyword extracting unit 11 outputs the extracted keyword as the auxiliary keyword. An evaluation point calculated from the importance can be added to the auxiliary keyword as attribute information. The evaluation point can simply indicate the order of importance, or can be a weight corresponding to the importance.

The search request unit 12 transfers a search request including the input keyword transferred from the user I/F unit 10 and the auxiliary keyword transferred from the keyword extracting unit 11.

The search unit 20 searches the information storage unit 21 by AND search using the input keyword and the auxiliary keyword transferred from the search request unit 12 connected by AND, and transfers the search result to the result notification unit 22.

The information storage unit 21 is at least one document database or file storing a plurality of document files including Web documents described in HTML, XML, and the like beforehand or documents described by an application, such as a word processor.

In the AND search, normally, search is performed by giving much weight to the input keyword than the auxiliary keyword, but in the case of an auxiliary keyword added with the evaluation point as the attribute information, search reflecting the evaluation point in weighting is performed (the processing by the search unit 20 is performed by a search service generally referred to as a search engine).

OR search in which the input keyword and the auxiliary keyword are OR-connected can be used for the search.

The result notification unit 22 creates a Web page in which the attribute information such as title, abstract, and URL indicating the location of the document, or the location of the related document is added to the respective documents as the search result transferred from the search unit 20, which can be displayed by one of the following display methods, and transfers the Web page to the user I/F unit 10. The display order can be a ranking order of the information desired by the user, from the search conditions such as the input keyword and the auxiliary keyword.

A first display method is a Web page in which a document or information as the search result is directly displayed on each tab is created so that a plurality of pages can be changed over and displayed, like a tab browser.

A second display method is a Web page in which a URL list as the search result is displayed is created so that the search result can be displayed by usual browser display or a special-purpose result display dialog.

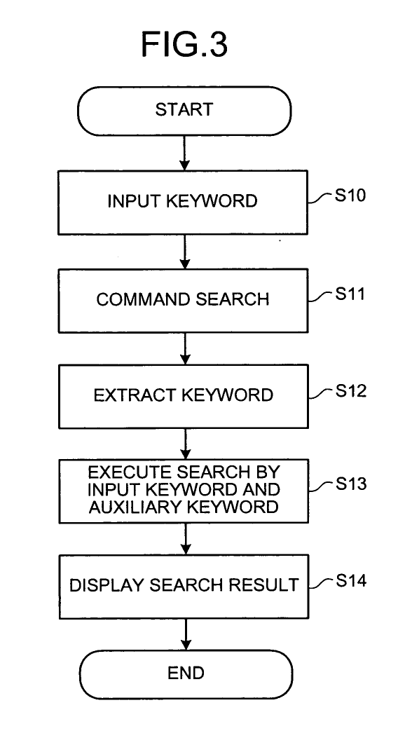

The processing procedure of the first embodiment will be explained with reference to the flowchart in FIG. 3.

The user inputs a part of a browsed document or a word as the input keyword by the mouse operation (step S10), and selects the search service (step S11).

A keyword is extracted from the browsed document and the keyword is designated as the auxiliary keyword (step S12). Extraction of the keyword is performed in the following manner. That is, the range for extracting the keyword is set to be in the near range of the input keyword selected from the browsed document, in the range displayed in the window, or the whole browsed document, and divided into the word strings with the part of speech by the morpheme analysis. The basic keyword DB 113 is referred to extract the importance of each word in the divided word strings, and the importance is arranged in order of the degree of importance. Predetermined number of words (for example, three) are extracted from the one having the highest importance and designated as the auxiliary keyword.

The document files including Web documents or documents created by the application is searched by the AND search combining the input keyword and the auxiliary keyword (step S13).

In the AND search, normally, search is performed by giving much weight to the input keyword than the auxiliary keyword, but in the case of an auxiliary keyword added with the evaluation point as the attribute information, search reflecting the evaluation point in weighting is performed.

A Web page in which the attribute information such as title, abstract, and URL indicating the location of the document, or the location of the related document is added to the respective documents as the search result is created, displayed and output to the display unit and the output unit (step S14). The display order can be a ranking order of the information desired by the user from the search conditions such as the input keyword and the auxiliary keyword.

With the above configuration, by using the contents of the browsed document in addition to the keyword input by the user, the search result intended by the user can be obtained by using only one input keyword, while maintaining the comfortable conventional operation environment by using the mouse.

A problem in the first embodiment is that since the auxiliary keyword is determined from only the document browsed at present, information is not enough, and hence, the interest of the user may not be taken out precisely.

Therefore, according to a second embodiment of the present invention, not only the browsed document, but also the input keyword for obtaining the browsed document and information of the browed document are included as context information.

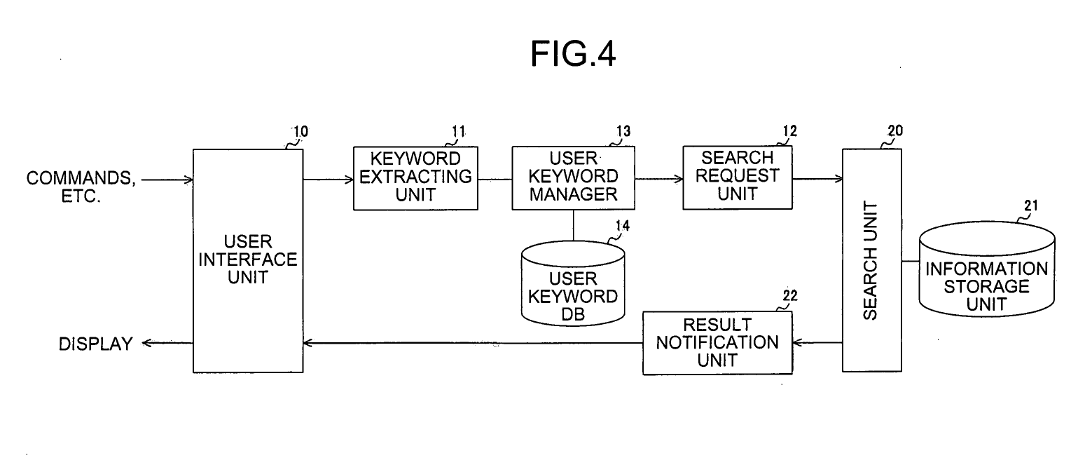

FIG. 4 is a block diagram of the functional configuration in the second embodiment for improving the auxiliary keyword by using the keyword extracted by the keyword extracting unit 11. In FIG. 4, the functional configuration of the second embodiment includes the user I/F unit 10, the keyword extracting unit 11, the user keyword manager 13, the user keyword DB 14, the search request unit 12, the search unit 20, the information storage unit 21, and the result notification unit 22. Like reference signs refer to like parts in the first embodiment, and only different points from the first embodiment will be explained.

The user keyword DB 14 is a data file holding a use history of the keywords extracted from the document browsed by the user, which keeps the accumulating total of the keywords and the evaluation points or the accumulating total of the count of the keyword for each keyword.

The user keyword manager 13 extracts the evaluation point (or the count) corresponding to the keyword registered in the user keyword DB 14, arranges the evaluation point of the keyword in decreasing order of size, and extracts a predetermined number of keywords (for example, three) from the one having the highest evaluation point as an auxiliary keyword.

The user keyword manager 13 refers to the user keyword DB 14, and when there is no keyword transferred from the keyword extracting unit 11, the user keyword manager 13 newly registers the keyword. When newly registering the keyword, if the evaluation point is added to the keyword, the evaluation point is set as an initial value. When the evaluation,point is not added to the keyword, “1” is set as a count.

When there is the keyword transferred from the keyword extracting unit 11 in the user keyword DB 14, if the evaluation point is added to the keyword, the user keyword manager 13 adds the evaluation point to the same keyword and updates the user keyword DB 14. If the evaluation point is not added to the keyword, the count is increased by 1 to update the user keyword DB 14.

The reason why the user keyword DB 14 is updated after having transferred the auxiliary keyword to the search request unit 12 is to eliminate the influence of the keyword extracted from the currently browsed document on the evaluation point and the count, and to determine the auxiliary keyword by the historical information.

Even if the keyword has been frequently used in the past and not frequently used recently, maintenance is performed so that the keyword is not selected as the auxiliary keyword, for example, once in every month, in the user keyword DB 14. In this case, the latest update date and time of the evaluation point is held together with the respective keywords in the user keyword DB 14, so that the evaluation point is decreased as the interval between the latest update date and time and the present date increases.

Furthermore, the evaluation point can be added not only to the update of the keyword extracted from the browsed document, but also to a similar word of the keyword. The evaluation point with respect to the similar word can be summed up, for example, by weighting to the evaluation point of the keyword.

As the keyword accumulated in the user keyword DB 14, not only the keyword extracted from the browsed document but also the input keyword can be registered. Since the input keyword is often included in the keyword extracted from the browsed document, there is little merit by registering the input keyword. However, when weighting is performed with respect to the total of the evaluation point by the input keyword and the keyword extracted from the browsed document, this method is useful.

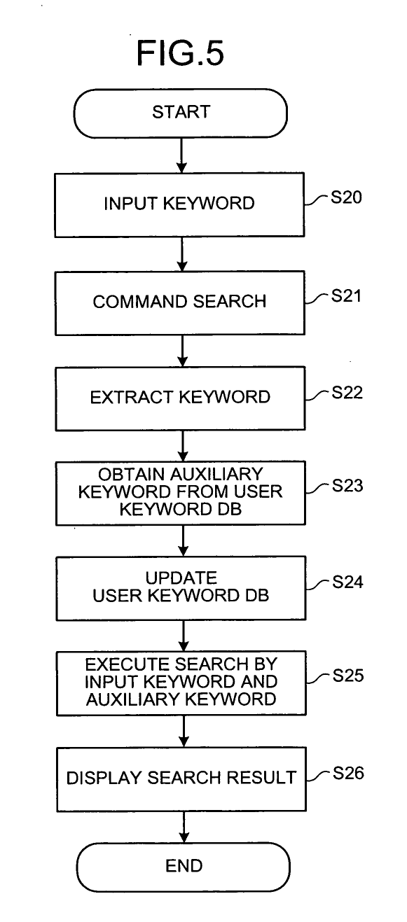

The processing procedure in the second embodiment will be explained with reference to the flowchart in FIG. 5.

The user inputs a part or a word of the browsed document as the input keyword by the mouse operation (step S20), to select the search service (step S21).

The keyword is then extracted from the browsed document (step S22). Extraction of the keyword is performed in such a manner that the range for extracting the keyword is set to be in the near range of the input keyword selected from the browsed document, in the range displayed in the window, or the whole browsed document, and divided into the word strings with the part of speech by the morpheme analysis. The basic keyword DB 113 is then referred to extract the importance of each word in the divided word strings, and the importance is arranged in order of the degree of importance. Predetermined number of words (for example, three) are extracted from the one having the highest importance and designated as the keyword.

The evaluation point (or the count) corresponding to the keyword registered in the user keyword DB 14 is extracted and arranged in decreasing order, and a predetermined number of keywords (for example, three) having the largest evaluation point is extracted and set as the auxiliary keyword (step S23).

The user keyword DB 14 is updated by using the keyword extracted from the browsed document (step S24).

When there is no extracted keyword in the user keyword DB 14, the keyword is newly registered. When newly registered, if the evaluation point is added to the keyword, the evaluation point is set as the initial value. When newly registering the keyword, if the evaluation point is added to the keyword, the evaluation point is set as an initial value. When the evaluation point is not added to the keyword, “1” is set as a count.

When there is the extracted keyword in the user keyword DB 14, if the evaluation point is added to the keyword, the evaluation point is added to the same keyword to update the user keyword DB 14. If the evaluation point is not added to the keyword, the count is increased by 1 to update the user keyword DB 14.

Furthermore, the evaluation point can be added not only to the update of the keyword, but also to a similar word of the keyword. The evaluation point with respect to the similar word can be summed up, for example, by weighting to the evaluation point of the keyword.

A plurality of document files including Web documents or documents created by the application is searched by AND search using the input keyword and the auxiliary keyword (step S25).

In the AND search, normally, search is performed by giving much weight to the input keyword than the auxiliary keyword, but in the case of an auxiliary keyword added with the evaluation point as the attribute information, search reflecting the evaluation point in weighting is performed.

A Web page in which the attribute information such as title, abstract, and URL indicating the location of the document, or the location of the related document is added to the respective documents as the search result is created, displayed and output to the display unit and the output unit (step S26). The display order can be a ranking order of the information desired by the user from the search conditions such as the input keyword and the auxiliary keyword.

With the above configuration, by using the contents of the browsed document in addition to the keyword input by the user, the search result intended by the user can be obtained by using only one input keyword, while maintaining the comfortable conventional operation environment by using the mouse.

According to the second embodiment, the problem of using the user keyword DB 14 is that when an individual has a plurality of independent interests such as work and hobbies, it is not desirable to handle these interests as one user interest information.

For example, when there is IT related matter as the interest in work, there are welfare and NGO activities as the social interest, and there are music, art, and cooking as the interest in hobbies, if one homogeneous user keyword DB14 is used, high search accuracy cannot be obtained.

There are three methods that can solve this problem as described below.

The first method is to classify the interest information and input to which category the present interest belongs, every time the user searches something. This method imposes a large burden on the user, and hence, does not satisfy the object of the present invention, that is, to perform accurate search by specifying one keyword by the user.

The second method is such that the category of the browsed document is automatically determined, and a keyword in the same category as this one and having the largest evaluation point is extracted from the user keyword DB 14. The keyword extracted from the browsed document is used to update the user keyword DB 14 according to the category of the browsed document.

This method can be realized by replacing the user keyword manager 13 and the user keyword DB 14 by the above function.

The third method is a method related to a third embodiment of the present invention, in which a co-occurrence frequency user keyword DB 15 is used instead of the user keyword DB 14.

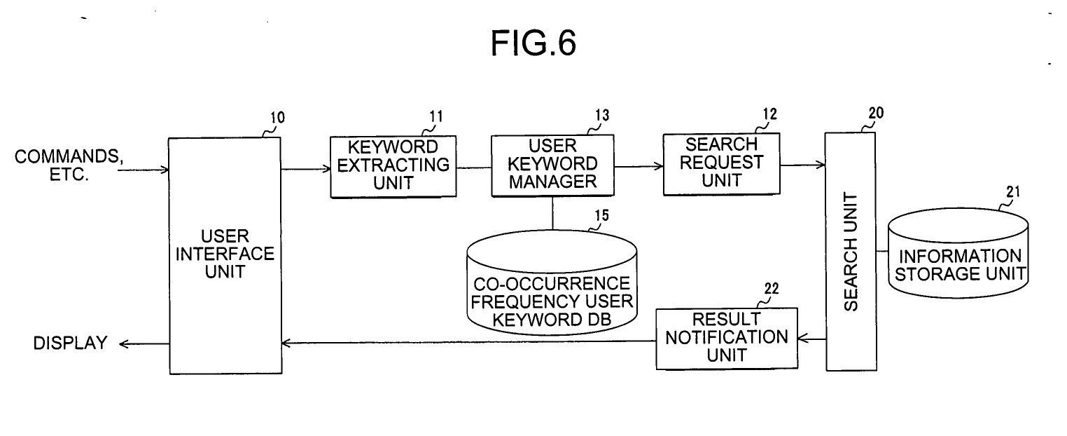

FIG. 6 is a block diagram of the functional configuration of the third embodiment, which improves the auxiliary keyword by using a keyword extracted by the keyword extracting unit 11. In FIG. 6, the functional configuration according to the third embodiment includes the user I/F unit 10, the keyword extracting unit 11, the user keyword manager 13, the co-occurrence frequency user keyword DB 15, the search request unit 12, the search unit 20, the information storage unit 21, and the result notification unit 22. Like functions as in the first and the second embodiments are designated with like reference numerals, and only different points will be explained below.

According to the present invention, a keyword appearing in the browsed document is defined as an “extracted keyword co-occurring with the input keyword” with respect to the keyword input by the user, and a co-occurrence evaluation point or a frequency of simultaneous appearance (hereinafter as co-occurrence frequency) is used to express the intensity of the co-occurrence relation.

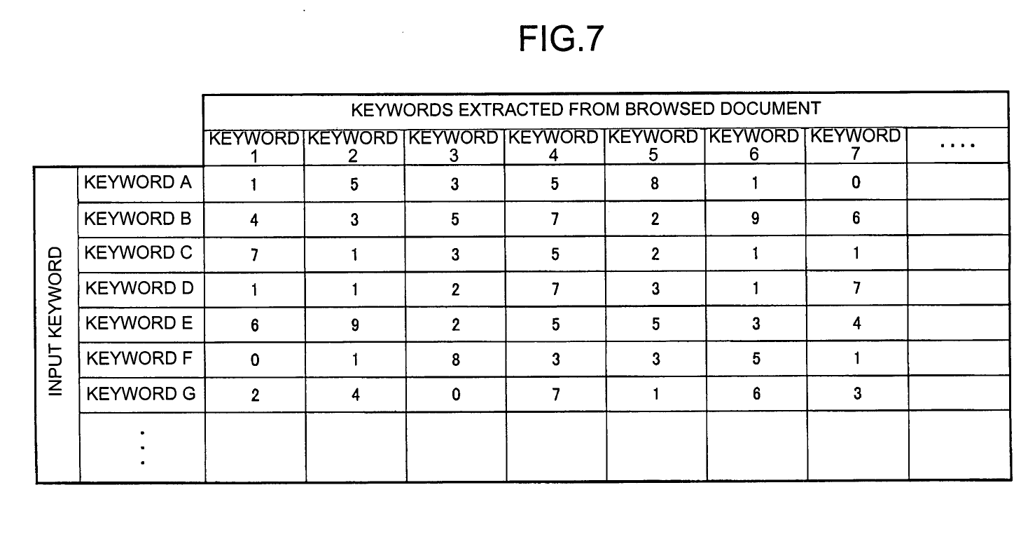

According to the third embodiment, the keyword in the co-occurrence relation and the co-occurrence evaluation point or the co-occurrence frequency are recorded in the co-occurrence frequency user keyword DB 15 shown in FIG. 7.

In FIG. 7, keywords in the longitudinal direction indicate the input keywords, and keywords in the horizontal direction indicate the keywords extracted from the browsed document, and it is expressed that the keywords in the longitudinal and horizontal directions co-occur. In cells specified by the keywords in the longitudinal and horizontal directions, when the input keyword is specified in the longitudinal direction, the co-occurrence evaluation point or the co-occurrence frequency of the keyword extracted from the browsed document is accumulated and set.

The user keyword manager 13 refers to the co-occurrence frequency user keyword DB 15, to extract the co-occurrence evaluation point or the co-occurrence frequency of the keyword co-occurring with the input keyword, the extracted co-occurrence evaluation point or co-occurrence frequency is arranged in decreasing order, and a predetermined number of keywords (for example, three) are extracted from the one having the largest number and designated as the auxiliary keyword.

The user keyword manager 13 refers to the co-occurrence frequency user keyword DB 15, and when items with respect to the input keyword and the extracted keyword are not registered, the unregistered keyword is newly registered. When newly registering the keyword, if an evaluation point is added to the extracted keyword, the evaluation point is set as an initial value of the co-occurrence evaluation point. When the evaluation point is not added, “1” is set as the co-occurrence frequency.

Furthermore, the user keyword manager 13 refers to the co-occurrence frequency user keyword DB 15, and when the input keyword and the extracted keyword are present, and if an evaluation point is added to the extracted keyword, the evaluation point is added to update the co-occurrence frequency user keyword DB 15. When the evaluation point is not added, the frequency is counted up by 1, to update the co-occurrence frequency user keyword DB 15.

The reason why the co-occurrence frequency user keyword DB 15 is updated after the auxiliary keyword is transmitted to the search request unit 12 is to eliminate the influence of the keyword extracted from the currently browsed document on the evaluation point and the count, and to determine the auxiliary keyword by the historical information.

A maintenance is performed with respect to the co-occurrence frequency user keyword DB 15 for example one a month, so that even a keyword frequently used in the past is not selected as the auxiliary keyword, if it is not frequently used recently. In this case, the maintenance is carried out in such a manner that the last update date and time of the evaluation point is stored together with the respective keyword in the co-occurrence frequency user keyword DB 15, and as the time interval between the last update date and time and the current date and time increases, the evaluation point is decreased.

The evaluation point can be added not only to the update of the keyword extracted from the browsed document, but also to a similar word of the keyword. The evaluation point with respect to the similar word can be summed up, for example, by weighting to the evaluation point of the keyword.

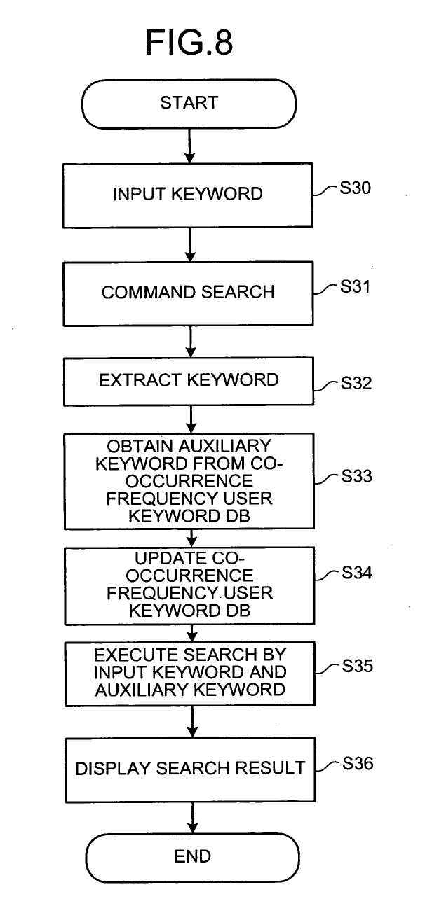

The processing procedure in the third embodiment will be explained with reference to the flowchart shown in FIG. 8. A user inputs a part of a browsed document or a word as an input keyword by the mouse operation (step S30), and selects the search service (step S31).

A keyword is extracted from the browsed document (step S32). Extraction of the keyword is performed in the following manner. That is, the range for extracting the keyword is set to be in the near range of the input keyword selected from the browsed document, in the range displayed in the window, or the whole browsed document, and divided into the word strings with the part of speech by the morpheme analysis. The basic keyword DB 113 is referred to extract the importance of each word in the divided word strings, and the importance is arranged in order of the degree of importance. Predetermined number of words (for example, three) are extracted from the one having the highest importance and designated as the keyword.

The co-occurrence frequency user keyword DB 15 is referred to extract the co-occurrence evaluation point or the co-occurrence frequency of the keyword co-occurring with the input keyword, the extracted co-occurrence evaluation point or co-occurrence frequency is arranged in decreasing order, and predetermined number of keywords (for example, three) are extracted from the one having the largest number and designated as the auxiliary keyword (step S33).

The co-occurrence frequency user keyword DB 15 is updated by using the input keyword and the extracted keyword (step S34).

The co-occurrence frequency user keyword DB co-occurrence frequency user keyword DB 15 is referred, and when items with respect to the input keyword and the extracted keyword are not registered, the unregistered keyword is newly registered. When newly registering the keyword, if an evaluation point is added to the extracted keyword, the evaluation point is set as an initial value of the co-occurrence evaluation point. When the evaluation point is not added, “1” is set as the co-occurrence frequency.

The co-occurrence frequency user keyword DB 15 is referred, and when the input keyword and the extracted keyword are present, and if an evaluation point is added to the extracted keyword, the evaluation point is added, to update the co-occurrence frequency user keyword DB 15. If an evaluation point is not added to the extracted keyword, the frequency is counted up by 1, to update the co-occurrence frequency user keyword DB 15.

The evaluation point can be added not only to the update of the keyword extracted from the browsed document, but also to a similar word of the keyword. The evaluation point with respect to the similar word can be summed up, for example, by weighting to the evaluation point of the keyword.

A plurality of document files including Web documents or documents created by the application is searched by AND search using the input keyword and the auxiliary keyword (step S35). In the AND search, normally, search is performed by giving much weight to the input keyword than the auxiliary keyword, but in the case of an auxiliary keyword added with the evaluation point as the attribute information, search reflecting the evaluation point in weighting is performed.

A Web page in which the attribute information such as title, abstract, and URL indicating the location of the document, or the location of the related document is added to the respective documents as the search result is created, displayed and output to the display unit and the output unit (step S36). The display order can be a ranking order of the information desired by the user from the search conditions such as the input keyword and the auxiliary keyword.

With the above configuration, by using the contents of the browsed document in addition to the keyword input by the user, the search result intended by the user can be obtained by using only one input keyword, while maintaining the comfortable conventional operation environment by using the mouse.

According to the present embodiments, the keyword extracting unit is an essential component, but when the user keyword DB is used, an update by using only the input keyword is also effective as the context information.

A fourth embodiment of the present invention has a configuration in which the keyword extracting unit 11 is removed from the configuration of the second embodiment.

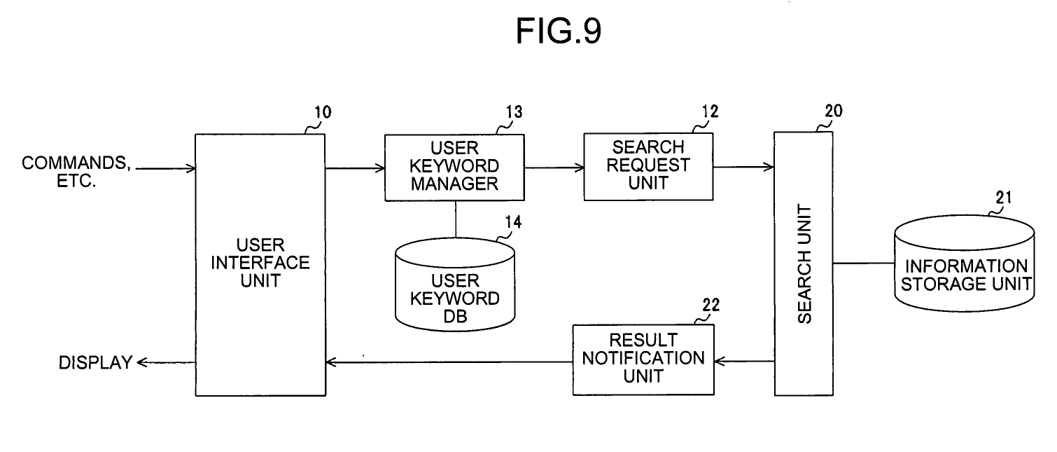

FIG. 9 is a block diagram of the functional configuration of the fourth embodiment. The functional configuration of the fourth embodiment includes the user I/F unit 10, the user keyword manager 13, the user keyword DB 14, the search request unit 12, the search unit 20, the information storage unit 21, and the result notification unit 22. Like reference signs refer to like parts in the second embodiment, and only different points will be explained.

When a user inputs a keyword and a search command, the user I/F unit 10 sends a search request added with the input keyword to the user keyword manager 13.

The user keyword DB 14 is a data file for storing the use history of the keyword input by the user, and maintains the keyword and the sum total of the use frequency for each input keyword.

The user keyword manager 13 arranges the use frequency of the keyword extracted from the user keyword DB 14 in decreasing order, and predetermined number of keywords (for example, three) are extracted from the one having the largest number and designated as the auxiliary keyword.

The user keyword manager 13 refers to the user keyword DB 14, and when there is no input keyword, the input keyword is newly registered. When newly registering the input keyword, “1” is set as an accumulated of the use frequency.

When the input keyword is present in the user keyword DB 14, the user keyword manager 13 counts up the use frequency by 1, to update the user keyword DB 14.

The reason why the user keyword DB 14 is updated after having transferred the auxiliary keyword to the search request unit 12 is to eliminate the influence of the keyword extracted from the currently browsed document on the evaluation point and the count, and to determine the auxiliary keyword by the historical information.

A maintenance is performed with respect to the user keyword DB 14 for example one a month, so that even a keyword frequently used in the past is not selected as the auxiliary keyword, if it is not frequently used recently. In this case, the maintenance is carried out in such a manner that the last update date and time of the accumulated,value of the use frequency is stored together with the respective keyword in the user keyword DB 14, and as the time interval between the last update date and time and the current date and time increases, the evaluation point is decreased.

The evaluation point can be added not only to the update of the input keyword, but also to a similar word of the input keyword. The evaluation point with respect to the similar word can be summed up, for example, by weighting to the use frequency of the input keyword.

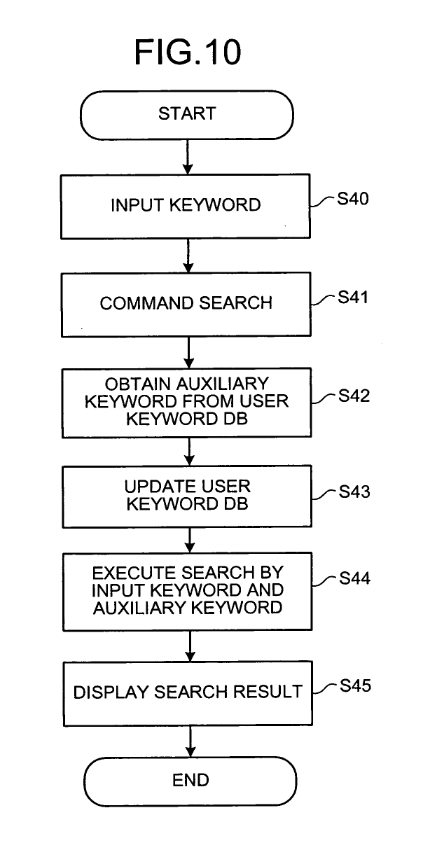

The processing procedure in the fourth embodiment will be explained with reference to the flowchart shown in FIG. 10. A user inputs a part of a browsed document or a word as an input keyword by the mouse operation (step S40), and selects the search service (step S41).

The use frequency of the keyword extracted from the user keyword DB 14 is arranged in decreasing order, and predetermined number of keywords (for example, three) are extracted from the one having the largest number and designated as the auxiliary keyword (step S42).

The user keyword DB 14 is updated by using the input keyword (step S43).

When there is no input keyword in the user keyword DB 14, the input keyword is newly registered. When newly registering the keyword, “1” is set as the initial value of the accumulated value of the use frequency. When the input keyword is present in the user keyword DB 14, the use frequency is counted up by 1, to update the user keyword DB 14.

The evaluation point can be added not only to the update of the input keyword, but also to a similar word of the input keyword. The evaluation point with respect to the similar word can be summed up, for example, by weighting to the use frequency of the keyword.

A plurality of document files including Web documents or documents created by the application is searched by AND search using the input keyword and the auxiliary keyword (step S44). In the AND search, normally, search is performed by giving much weight to the input keyword than the auxiliary keyword, but in the case of an auxiliary keyword added with the evaluation point as the attribute information, search reflecting the evaluation point in weighting is performed.

A Web page in which the attribute information such as title, abstract, and URL indicating the location of the document, or the location of the related document is added to the respective documents as the search result is created, displayed and output to the display unit and the output unit (step S45). The display order can be a ranking order of the information desired by the user from the search conditions such as the input keyword and the auxiliary keyword.

With the above configuration, by using the contents of the browsed document in addition to the keyword input by the user, the search result intended by the user can be obtained by using only one input keyword, while maintaining the comfortable conventional operation environment by using the mouse.

An advertising search service in which as a collateral measure for providing a comfortable operation environment, such as searching a document associated with one keyword specified by a user and providing the search result to the user, advertising information close to the users' interests is provided to realize a high click ratio will be explained below as an example of the advertising search system. The advertising search service will be explained based on the information search system described above, but the configuration can be such that only the advertising search service is performed based on the keyword input by the user and the auxiliary keyword extracted from the browsed document.

The advertising search service of the present invention is not limited to the advertising search service targeting the information search service, and can be easily applied to the advertising search service targeting dictionary service, translation service, and the like.

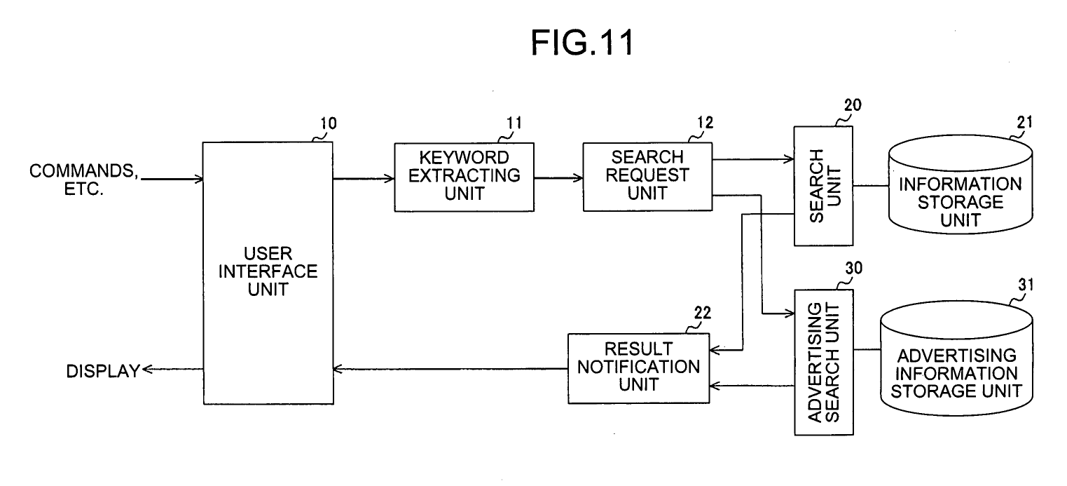

FIG. 11 is a block diagram of the functional configuration of the advertising search system according to a fifth embodiment of the present invention. As shown in FIG. 11, the advertising search system includes a user interface (hereinafter, “user I/F”) unit 10, a keyword extracting unit 11, a search request unit 12, a search unit 20, an information storage unit 21, a result notification unit 22, an advertising search unit 30, and an advertising information storage unit 31. Like reference signs refer to like parts in the first embodiment, and only different points will be explained.

The search request unit 12 transfers a search request added with an auxiliary keyword extracted by the keyword extracting unit 11 and an input keyword input by the user to the search unit 20 and the advertising search unit 30.

The advertising search unit 30 searches the advertising information storage unit 31 by the AND search of the input keyword and the auxiliary keyword transferred from the search request unit 12 and transfers the searched advertising content to the result notification unit 22. The advertising information storage unit 31 is at least one of the advertising content database or file that stores a plurality of advertising contents provided by an advertiser beforehand and advertising information including a keyword for searching the advertisement.

In the AND search, normally, search is performed by giving much weight to the input keyword than the auxiliary keyword, but in the case of auxiliary keyword added with the evaluation point as the attribute information, search reflecting the evaluation point in weighting is performed. The advertising search unit 30 can perform weighting of the input keyword and the auxiliary keyword different from that of the search unit 20.

The result notification unit 22 converts the advertising content of the search result transferred from the search unit 20 and the search result transferred from the advertising search unit 30 by either one of the following display methods, and transfers the advertising content to the user I/F unit 10.

When a plurality of pages can be switched and displayed as in the tab browser, a Web page which directly displays the search result transferred from the search unit 20 as a list added with the attribute information such as title, abstract, and URL indicating the location of the document, or the location of the related document for each searched document is created.

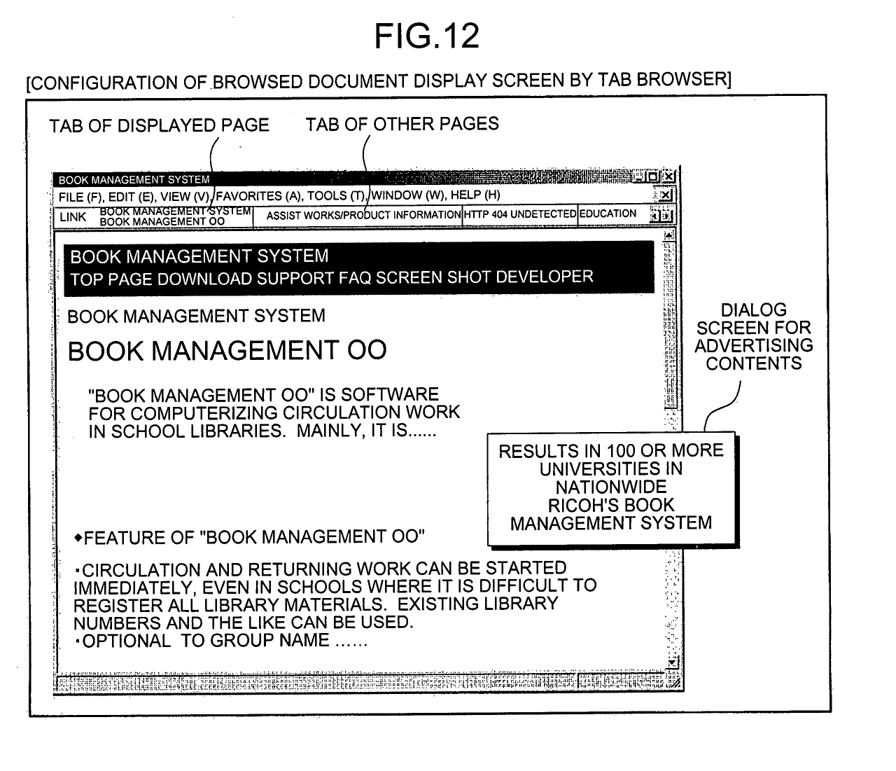

Furthermore, with respect to the advertising content for the search result transferred from the advertising search unit 30, a command to display the advertising content in a dialog for the advertising content is sent to the user I/F unit 10 (see FIG. 12).

A Web page which directly displays the search result transferred from the search unit 20 as a list added with the attribute information such as title, abstract, and URL indicating the location of the document, or the location of the related document for each searched document is created so that the search result can be displayed in the normal browser, and with respect to the advertising content for the search result transferred from the advertising search unit 30, a Web page in which the advertising content is displayed in the Web page is created.

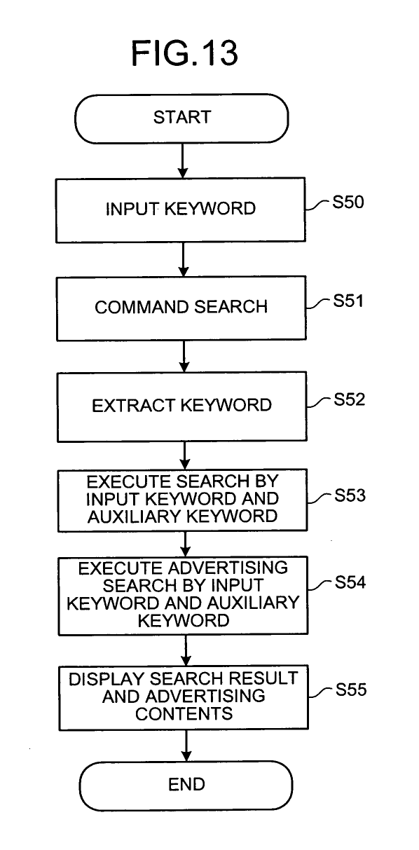

The processing procedure in the fifth embodiment will be explained with reference to the flowchart in FIG. 13.

The user inputs a part of the browsed document or a word as the input keyword (step S50), and selects the search service (step S51).

A keyword is extracted from the browsed document and the keyword is designated as the auxiliary keyword (step S52). Extraction of the keyword is performed in the following manner. That is, the range for extracting the keyword is set to be in the near range of the input keyword selected from the browsed document, in the range displayed in the window, or the whole browsed document, and divided into the word strings with the part of speech by the morpheme analysis. The importance of each word in the divided word strings is arranged in order of the degree of importance. Predetermined number of words (for example, three) are extracted from the one having the highest importance and designated as the auxiliary keyword.

A plurality of document files including Web documents or documents created by the application is searched by the AND search using the input keyword and the auxiliary keyword (step S53).

In the AND search, normally, search is performed by giving much weight to the input keyword than the auxiliary keyword, but in the case of an auxiliary keyword added with the evaluation point as the attribute information, search reflecting the evaluation point in weighting is performed.

The advertising content provided by the advertiser is searched by the AND search of the input keyword and the auxiliary keyword (step S54).

In the AND search, normally, search is performed by giving much weight to the input keyword than the auxiliary keyword, but in the case of an auxiliary keyword added with the evaluation point as the attribute information, search reflecting the evaluation point in weighting is performed. In the advertising search, the weighting to the input keyword and the auxiliary keyword can be different from that of the information search.

A Web page in which the attribute information such as title, abstract, and URL indicating the location of the document, or the location of the related document is added to the respective documents as the search result is created, displayed and output to the display unit and the output unit, and the searched advertising content is displayed on a dialog screen for the advertising content (step S55). The display order can be a ranking order of the information desired by the user from the search conditions such as the input keyword and the auxiliary keyword.

With the above configuration, an advertisement more suitable to user's interests can be provided when the user inputs one keyword, while maintaining the comfortable conventional operation environment by using the mouse. Accordingly, the click ratio of the advertising contents can be improved.

The impartiality of the search result may be in question as one problem of the advertising search service. The reason of high click ratio in the advertising search service is that only the advertising content corresponding to the input keyword, that is, the user's interest information can be displayed. In the conventional advertising search system, the search result of information specified by the user and advertising information are displayed harmoniously, and hence, there is a problem in that the user cannot easily distinguish whether the information is the one which the user desires or it is only an advertising.

In the advertising search system according to a sixth embodiment of the present invention, the search result of information specified by the user and advertising contents are separated and presented according to either one of the following methods, to solve the impartiality problem.

A first method is for searching an advertisement only by the auxiliary keyword. This method is logically impartial in a sense that the input keyword is not used. However, when the input keyword is an important keyword in the browsed document, the input keyword can be included in the auxiliary keyword. Accordingly, the impartiality is lower than the second method.

A second method is for searching an advertisement only by the auxiliary keyword, excluding the input keyword from the auxiliary keyword. Since this method can delete the advertising content related to information, in which the user does not have direct interest, sufficient impartiality in the search result can be provided.

The functional configuration of the sixth embodiment is the same as that of the fifth embodiment, but is different in that the advertising search unit 30 corrects the auxiliary keyword by either one of the above two methods to perform search.

That is, when having received the input keyword and the auxiliary keyword from the search request unit 12, the advertising search unit 30 corrects the auxiliary keyword by either one of the above two methods defined beforehand, and refers to the advertising information storage unit 31, to extract the advertising content by the AND search only of the corrected auxiliary keyword.

With the above configuration, the advertising content related to the input keyword can be eliminated from the search result. Accordingly, even when the input keyword is not the user's interest information, advertising maintaining the impartiality can be provided.

The method for obtaining the auxiliary keyword in the fifth and the sixth embodiments is such that, as in the first embodiment, a keyword is extracted from the browsed document, and designated as the auxiliary keyword. In this modification example, the method for obtaining the auxiliary keyword can be replaced by the method for obtaining the auxiliary keyword in the second, the third, and the fourth embodiments.

In such a modification example, an advertising content suitable the user's interest can be provided.

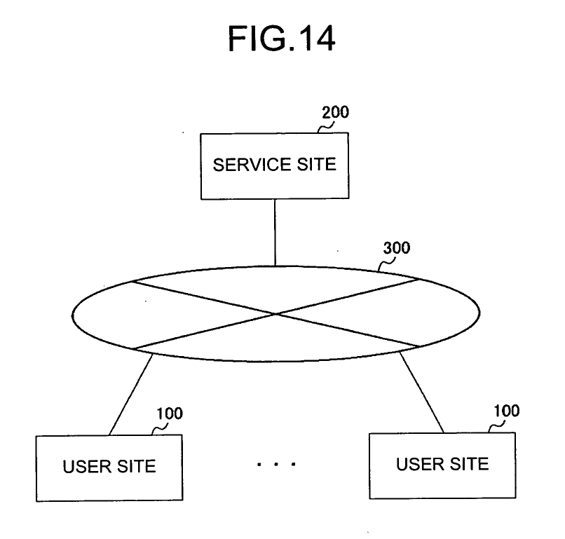

FIG. 14 is a block diagram of a seventh embodiment of the present invention, including a service site for providing information search or an advertising search service and user sites receiving the service. This embodiment includes an optional number of user sites 100, a service site 200 providing the search service, and a network 300.

The user site 100 is a terminal device for allowing a user to select a part of a browsed document or a word as the input keyword by mouse operation and displaying information received from a service provider with respect to the keyword. The user site 100 can be any one of a personal computer, a personal digital assistant (PDA), and the like, and needs only to be a terminal device capable of executing the Web browser.

The service site 200 is a computer system for providing the information search service, the dictionary service, and the translation service, and providing advertising contents corresponding to service requests from the user sites 100, and has the Web server function. In the explanation below, while the same service provider provides two services, that is, the information search service and the advertising search service in the service site 200, different service providers can also have respective service sites to provide the respective services.

These user sites 100 and service site 200 respectively include a network communication interface so as to be connected via the network 300.

The network 300 is a transmission path for connecting the user sites 100 and the service site 200, and so long as the communication protocols between the user sites 100 and the service site 200 match each other, the network 300 can be wireless or wired, and for example, a local area network (LAN) and the Internet can be used.

In this explanation, it is assumed that the respective functions in the above embodiments are executed by either the user site 100 or the service site 200. Accordingly, explanation for the same function is omitted, and only additional and different functions will be explained.

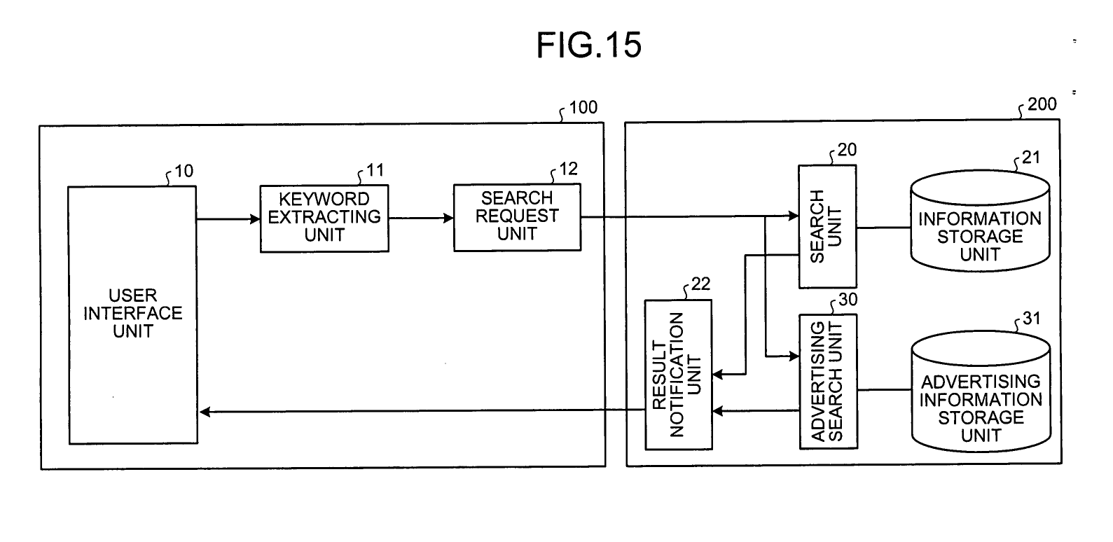

In the case of a configuration in which the auxiliary keyword is selected by the keyword extracting unit as in the first, the fifth, and the sixth embodiments, the configuration is as shown in FIG. 15, and the operations in the respective sites are the same as those described in the first, the fifth, and the sixth embodiments.

The user site 100 includes the user I/F unit 10, the keyword extracting unit 11, and the search request unit 12.

When providing only the information search service, the service site 200 includes the search unit 20, the information storage unit 21, and the result notification unit 22.

When providing both the information search service and the advertising search service, the service site 200 includes the search unit 20, the information storage unit 21, the advertising search unit 30, the advertising information storage unit 31, and the result notification unit 22.

However, the search request unit 12, the user I/F unit 10, the result notification unit 22, the search unit 20, and the advertising search unit 30 are different from those in the first, the fifth, and the sixth embodiments in that these units provide information to a communication counterpart via the network 300.

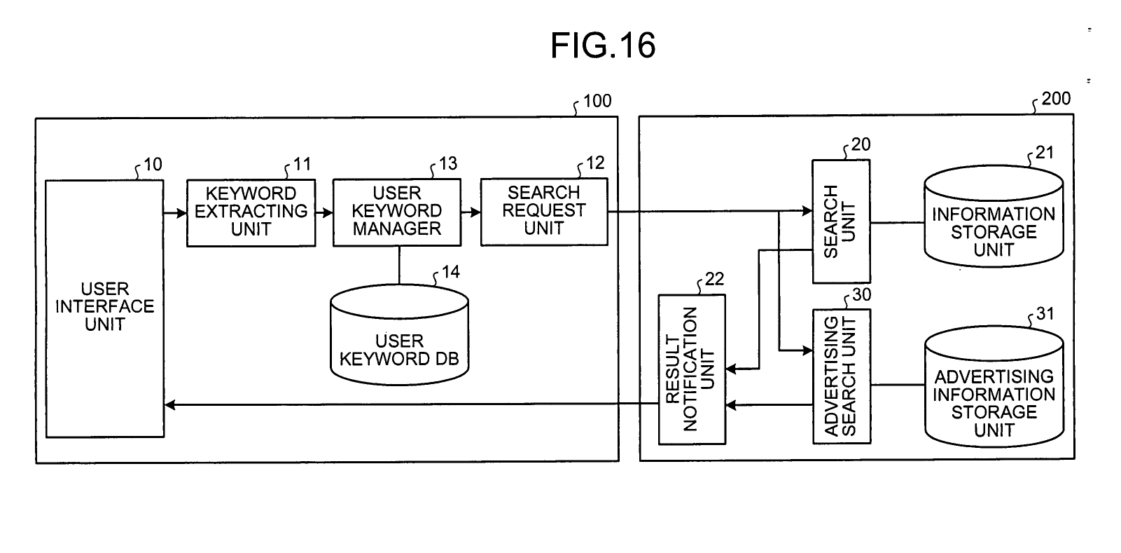

In the case of a configuration in which selection of the auxiliary keyword is performed by the user keyword manager in the second and the third embodiments, the configuration is as shown in FIG. 16, and the operations in the respective sites are the same as described in the second embodiment.

The user site 100 includes the user I/F unit 10, the keyword extracting unit 11, the user keyword manager 13, the user keyword DB 14, and the search request unit 12.

When providing only the information search service, the service site 200 includes the search unit 20, the information storage unit 21, and the result notification unit 22.

When providing both the information search service and the advertising search service, the service site 200 includes the search unit 20, the information storage unit 21, the advertising search unit 30, the advertising information storage unit 31, and the result notification unit 22.

However, the search request unit 12, the user I/F unit 10, the result notification unit 22, the search unit 20, and the advertising search unit 30 are different from those in the second embodiment in that these units provide information to the communication counterpart via the network 300.

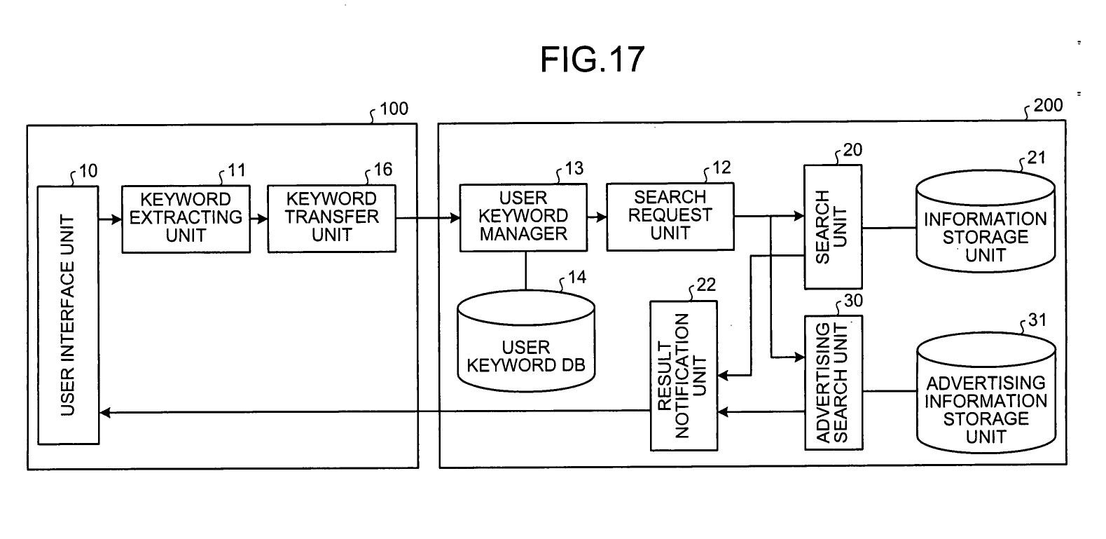

In the case of a configuration in which selection of the auxiliary keyword is performed by the user keyword manager as in the second embodiment, the configuration can be as shown in FIG. 17.

The user site 100 includes the user I/F unit 10, the keyword extracting unit 11, and a keyword transfer unit 16.

The keyword transfer unit 16 transfers a keyword input by the user I/F unit 10 to the user keyword manager 13 in the service site 200 via the network 300.

When providing only the information search service, the service site 200 includes the user keyword manager 13, the user keyword DB 14, the search request unit 12, the search unit 20, the information storage unit 21, and the result notification unit 22.

When providing both the information search service and the advertising search service, the service site 200 includes the user keyword manager 13, the user keyword DB 14, the search request unit 12, the search unit 20, the information storage unit 21, the advertising search unit 30, the advertising information storage unit 31, and the result notification unit 22.

However, the search request unit 12, the user I/F unit 10, and the result notification unit 22 are different from those in the second embodiment in that these units provide information to the communication counterpart via the network 300.

The user keyword manager 13 and the user keyword DB 14 in FIGS. 16 and 17 can be replaced by the user keyword manager 13 and the co-occurrence frequency user keyword DB 15 in the third embodiment.

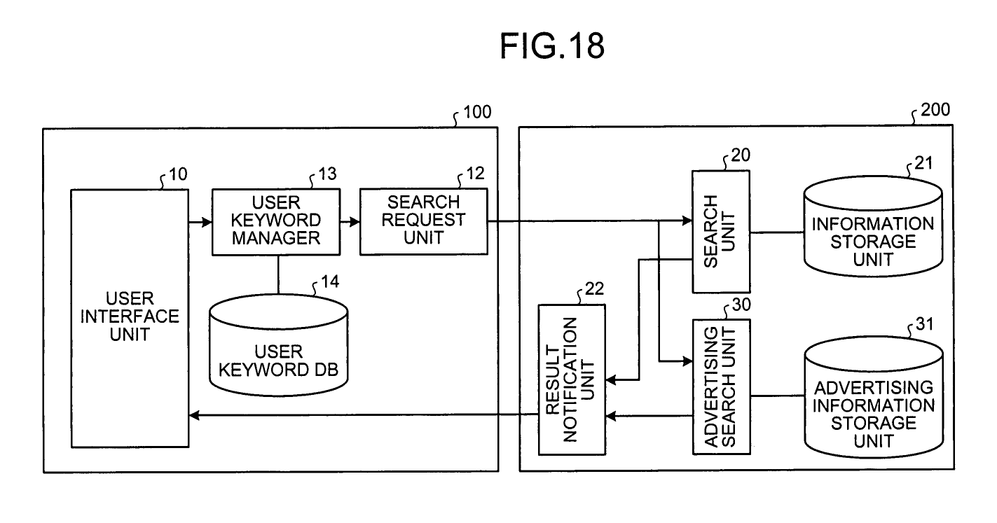

In the case of a configuration in which selection of the auxiliary keyword is performed by the user keyword manager by using the input keyword as in the fourth embodiment, the configuration is as shown in FIG. 18, and the operations in respective sites are the same as explained in the fourth embodiment.

The user site 100 includes the user I/F unit 10, the user keyword manager 13, the user keyword DB 14, and the search request unit 12.

When providing only the information search service, the service site 200 includes the search unit 20, the information storage unit 21, and the result notification unit 22.

When providing both the information search service and the advertising search service, the service site 200 includes the search unit 20, the information storage unit 21, the advertising search unit 30, the advertising information storage unit 31, and the result notification unit 22.

However, the search request unit 12, the user I/F unit 10, the result notification unit 22, the search unit 20, and the advertising search unit 30 are different from those in the fourth embodiment in that these units provide information to the communication counterpart via the network 300.

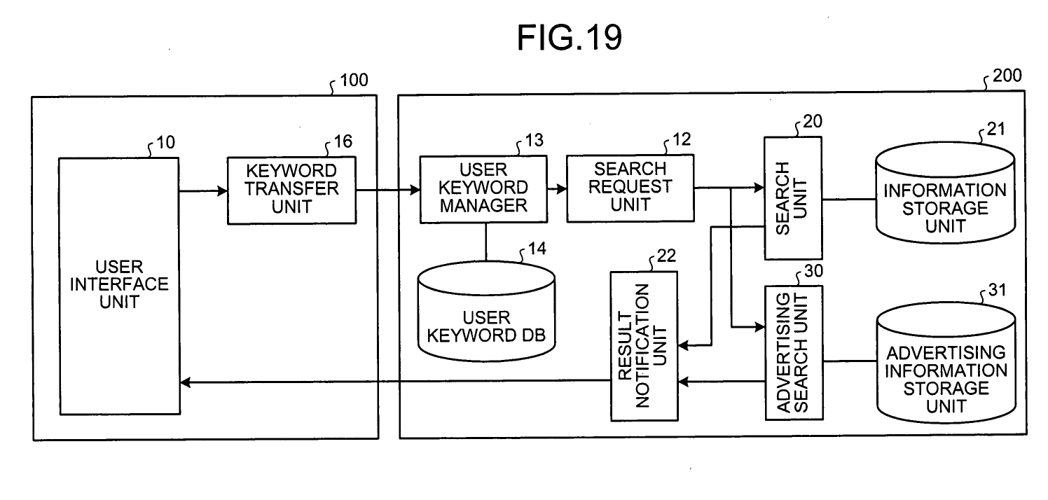

Furthermore, in the case of a configuration in which selection of the auxiliary keyword is performed by the user keyword manager by using the input keyword as in the fourth embodiment, the configuration can be also as shown in FIG. 19.

The user site 100 includes the user I/F unit 10, the keyword extracting unit 11, and the keyword transfer unit 16. The keyword transfer unit 16 transfers a keyword input by the user I/F unit 10 to the user keyword manager 13 in the service site 200 via the network 300.

When providing only the information search service, the service site 200 includes the user keyword manager 13, the user keyword DB 14, the search request unit 12, the search unit 20, the information storage unit 21, and the result notification unit 22.

When providing both the information search service and the advertising search service, the service site 200 includes the user keyword manager 13, the user keyword DB 14, the search request unit 12, the search unit 20, the information storage unit 21, the advertising search unit 30, the advertising information storage unit 31, and the result notification unit 22.

However, the keyword transfer unit 16, the user I/F unit 10, and the result notification unit 22 are different from those in the fourth embodiment in that these units provide information to the communication counterpart via the network 300.

Following effects can be provided by making the respective functions in the first to the sixth embodiments have the configuration of the user site and the service site in the seventh embodiment.

In the conventional search system, a high click ratio is realized by presenting an advertisement related to the keyword input by the user, and to realize the high click ratio, it is effective to obtain the user interest information in addition to the input keyword. However, the user interest information is related to user's privacy, and unless there is a merit for the user, permission for obtaining the privacy information can be hardly given.

Furthermore, according to a search engine method for obtaining a URL of the document browsed by the user, information about which document the user is browsing is obtained, and further, all information related to the document can be obtained. Accordingly, there is a high possibility of privacy violation.

However, as in the seventh embodiment, what is transferred from the user site 100 to the service site 200 is limited to the context information such as the input keyword and the keyword extracted from the document browsed by the user. Since it is difficult to identify the document browsed by the user from such keywords, the possibility of privacy violation becomes lower.

Even in the configuration of the seventh embodiment, there are still problems as follows:

(1) Even if only the auxiliary keyword is transferred to the service site, if the keywords are accumulated in the service site, there is a possibility of posing a risk to the user's privacy;

(2) When the user keyword DB and the co-occurrence frequency user keyword DB are maintained and managed by the user keyword manager in the service site, the service provider can access these databases at an optional timing, and hence, analysis of the user interest information and statistical processing with respect to many users become possible. Therefore, the service provider can realize improvement in the search accuracy and advertising content click ratio based on the analysis result. However, the analysis result for the user interest information can be related to the user's privacy, and if the information is leaked out, it can pose a risk to the user's privacy.

To solve the above problems, in the respective embodiments, when transferring the keywords extracted from the browsed document other than the input keyword, and the auxiliary keyword to the service site, filtering is performed in the user site, to exclude information related to the privacy and security.

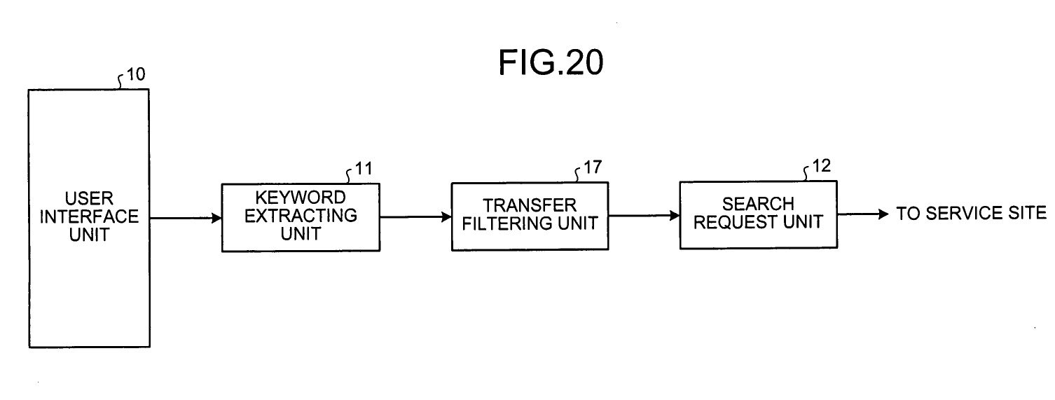

As the filtering spot, there are three patterns. In a first pattern, the auxiliary keyword is extracted from the browsed document by the keyword extracting unit 11, the auxiliary keyword is filtered by a transfer filtering unit 17, and the filtered auxiliary keyword is transferred to the search unit and the advertising search unit in the service site by the search request unit 12 (see FIG. 20).

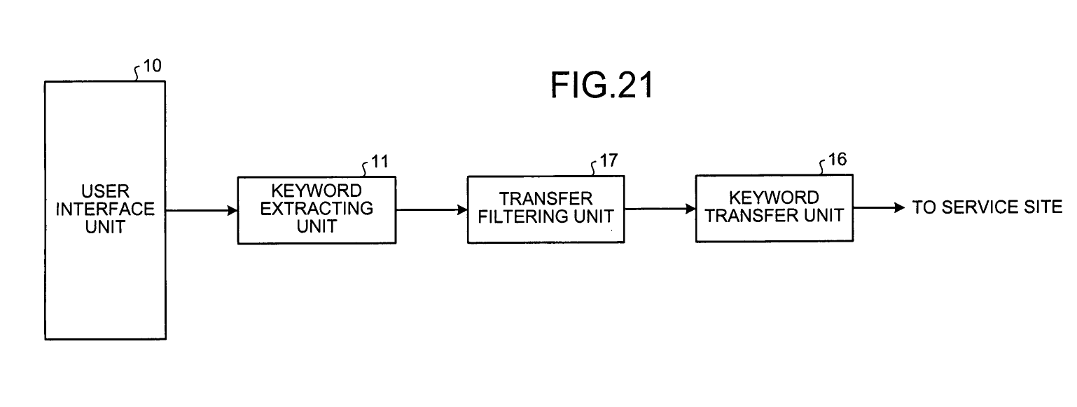

In a second pattern, the keyword is extracted from the browsed document by the keyword extracting unit 11, the keyword is filtered by the transfer filtering unit 17, and the filtered keyword is transferred to the user keyword manager in the service site by the search request unit 12 (see FIG. 21).

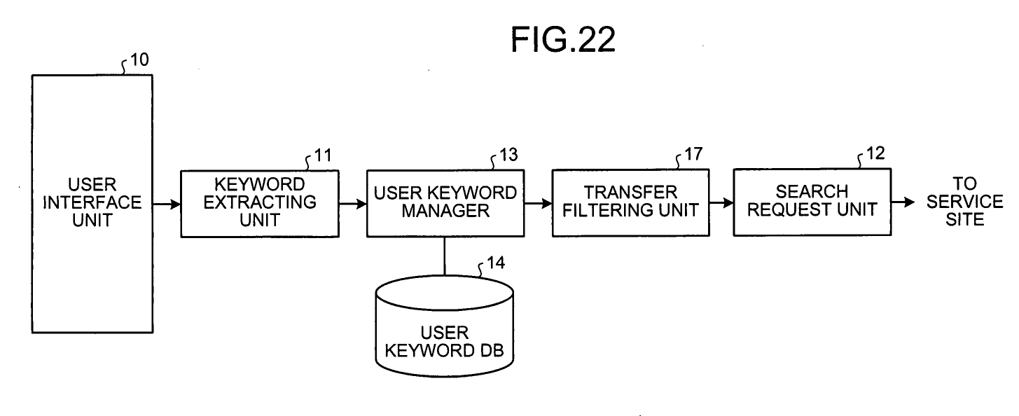

In a third pattern, the auxiliary keyword obtained by the user keyword manager 13 is filtered by the transfer filtering unit 17, and the filtered auxiliary keyword is transferred to the search unit and the advertising search unit in the service site by the search request unit 12 (see FIG. 22).

The database managed by the user keyword manager is applicable to the user keyword DB and to the co-occurrence frequency user keyword DB.

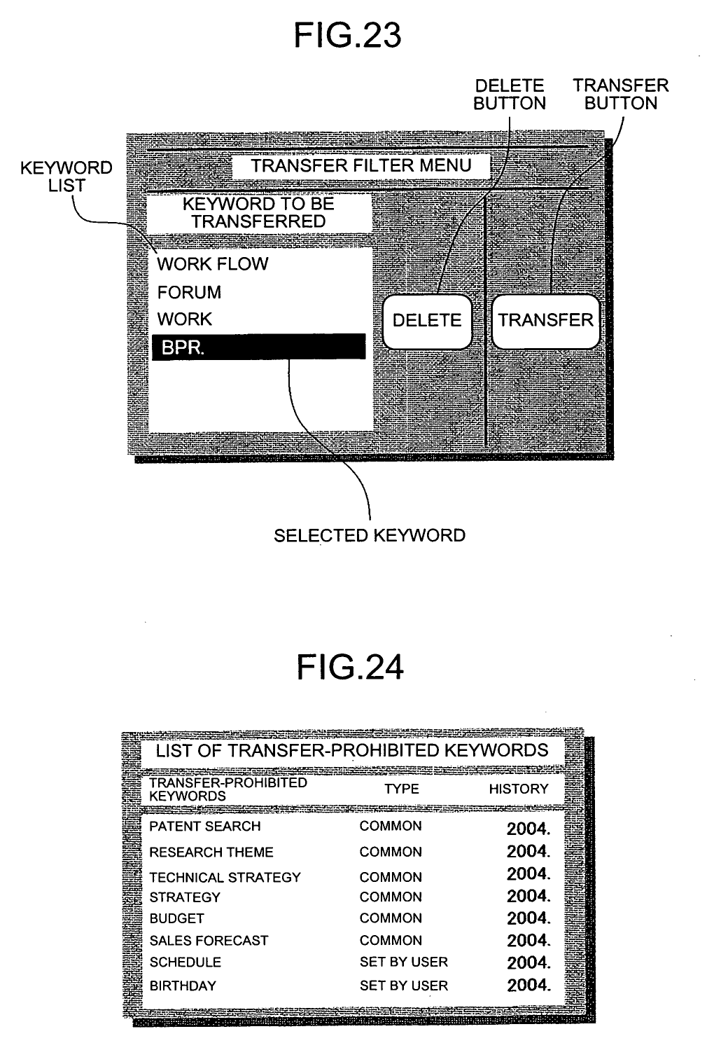

In the case of the first pattern, a list of the auxiliary keywords extracted from the browsed document by the keyword extracting unit 11 is presented to the user in a dialog as shown in FIG. 23.

The user selects an auxiliary keyword, the transfer of which the user wishes to prohibit, from the list of the displayed auxiliary keywords, and clicks a delete button. At a point in time when the auxiliary keyword, for which the transfer is prohibited, is deleted, the user clicks the transfer button.

The transfer filtering unit 17 transfers the auxiliary keywords remaining after clicking the transfer button (auxiliary keywords, for which the transfer is permitted) to the search unit and the advertising search unit in the service site via the search request unit 12.

According to this method, the keywords to be transmitted to the service site can be confirmed beforehand, and when there is a problem, a particular keyword can be deleted.

With this method, however, the user must determine whether to transfer the keyword every time. Therefore, this method is effective when there is little probability of transfer prohibition or when the number of auxiliary keywords to be transferred to the transfer filtering unit 17 is small.

Likewise, in the case of the second pattern, a transfer-prohibited keyword is deleted from the keywords extracted from the browsed document by the keyword extracting unit 11, and the remaining keywords are transferred to the user keyword manager in the service site via the keyword transfer unit 16.

In the case of the third pattern, a transfer-prohibited auxiliary keyword is deleted from the auxiliary keywords selected by the user keyword manager 13, and the remaining auxiliary keywords are transferred to the search unit or the advertising search unit in the service site via the search request unit 12.

If combined with the methods below, this method can determine whether to transfer a keyword, for which transfer has been automatically determined to be approved or denied, according to the judgment of the user.

At first, externally confidential keywords such as development code name are stored beforehand as transfer-prohibited keywords.

At the time of registration, the state of the keywords in the word table is listed and displayed according to the user's request (see FIG. 24). As types of keyword, there are “common” keywords, which are commonly set in the organization according to the security policy and cannot be edited by general users, and keywords “set by user”, which can be set by general users.

Users update the word table by performing addition, deletion, or edit of transfer-prohibited keywords, according to the authority provided.

The transfer-prohibited keywords are stored in the above word table, but only the transfer-approved keywords can be stored therein, or registered keywords can be stored therein together with transfer approval or denial.

In the case of the first pattern, the auxiliary keyword extracted from the browsed document by the keyword extracting unit 11 is compared with the keywords stored in the word table to determine whether transfer is approved or denied, and only the transfer-approved auxiliary keyword is transferred to the search unit or the advertising search unit in the service site via the search request unit 12.

According to this method, filtering can be performed automatically, so that a particular wording (project name and the like) is not included in the keywords in the document browsed by the user.

Likewise, in the case of the second pattern, the keyword extracted from the browsed document by the keyword extracting unit 11 is compared with the keywords stored in the word table to determine whether transfer is approved or denied, and only the transfer-approved keyword is transferred to the user keyword manager in the service site via the keyword transfer unit 16. In this case, only the transfer-approved keyword is registered in the user keyword DB or the co-occurrence frequency user keyword DB.

In the case of the third pattern, the auxiliary keyword selected by the user keyword manager 13 is compared with the keywords stored in the word table to determine whether transfer is approved or denied, and only the transfer-approved auxiliary keyword is transferred to the search unit or the advertising search unit in the service site via the search request unit 12.

In some cases, according to the type of the browsed document, all information related to the document is transfer-prohibited. For example, there are private letters and externally confidential documents concerned with company security, and in such cases, it is convenient if transfer approval/denial is determined in a unit of document.

For this purpose, at first, a document ID table including transfer-prohibited document ID table and a transfer-prohibited attribute table is stored beforehand.

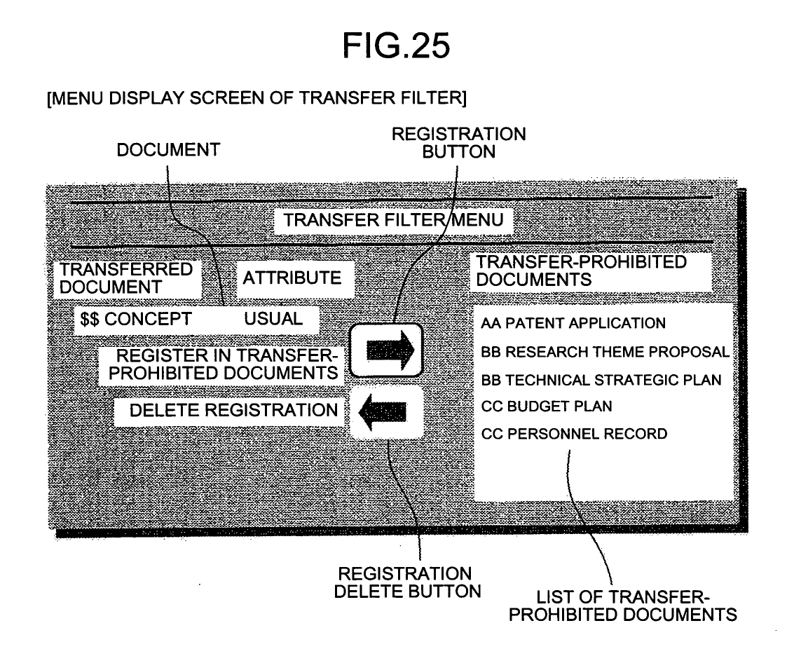

For the registration, a dialog shown in FIG. 25 is displayed, a document name to be transferred to the service site and the attribute (as the attribute, there are “usual”, “confidential”, and “internal use only”, or the like) are input, and a registration button is clicked. The document name and the attribute are then registered in a transfer-prohibited document list. Even if the attribute is “usual”, the document registered herein is handled automatically as the transfer-prohibited document.

When changing the document displayed in the transfer-prohibited document list to a transfer-approved document, the document is selected in the transfer-prohibited document list, and can be deleted by pressing a “registration delete button”.

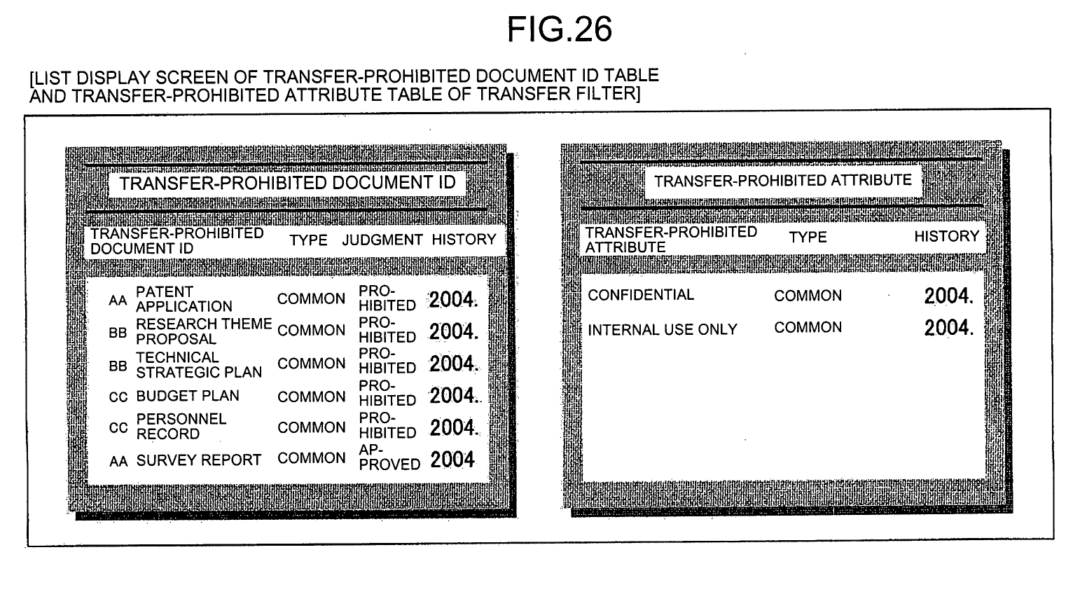

The document registered in the document ID table is registered as shown in FIG. 26.

Furthermore, the document ID table can register only the transfer-approved document IDs, and when the intended document is not registered in the document ID table, it is determined that the transfer of the document is prohibited, or transfer approval/denial can be registered with respect to the document ID.

In the case of the first pattern or the second pattern, the attribute information of the browsed document is compared with the transfer-prohibited attribute table, and if the attribute of the document is registered as a transfer-prohibited attribute, transfer of the extracted keyword is not performed. However, if the attribute information of the browsed document is not registered as the transfer-prohibited attribute, or is registered as a transfer-approved attribute, the browsed document ID is compared with the transfer-prohibited document ID table, and if the ID is registered as the transfer-prohibited document, transfer of the extracted keyword is not performed.

According to this method, transfer approval/denial of the keyword extracted from the browsed document can be automatically determined by referring to the document ID table.

Furthermore, if the transfer filtering unit is applied to the browsed document when the search command is issued, it is not necessary to extract the keyword with respect to the transfer-prohibited document.

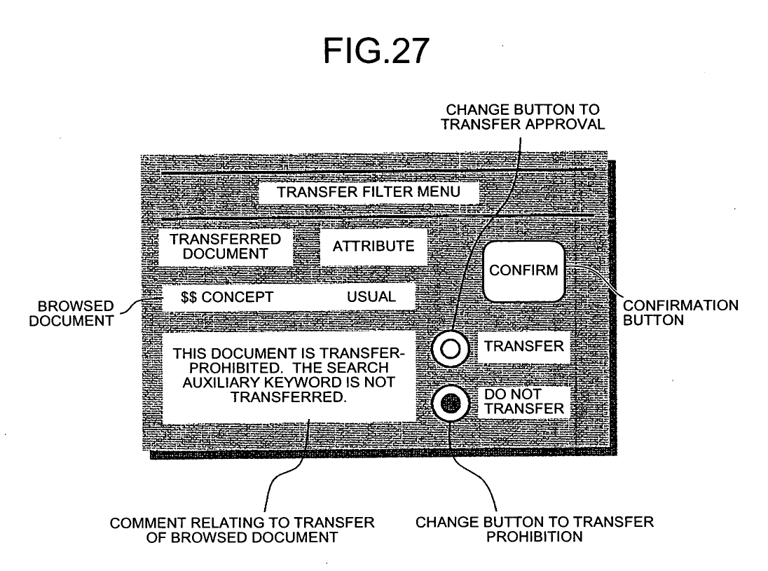

The evaluation result of the browsed document based on the document ID table can be confirmed by the user. For example, a dialog shown in FIG. 27 is displayed, and the user refers to the displayed comment, and if it is not appropriate, clicks a change button to transfer approval or to transfer denial, and then clicks the confirmation button. When there is a change to the transfer approval or to the transfer denial, the change is registered in the document ID table to update the document ID table.

When combining filters in (2) and (3), as a first example, the word table of (2) is applied to the keyword extracted from the transfer-approved document according to the method of (3), to determine the transfer-prohibited keyword. As a second example, on the contrary, the word table of (2) is applied to the keyword extracted from the transfer-prohibited document according to the method of (3), to determine the transfer-approved keyword.

In this case, since transfer approval/denial can be determined with respect to an individual keyword, for which transfer approval/denial has been determined, safety of privacy can be further improved.

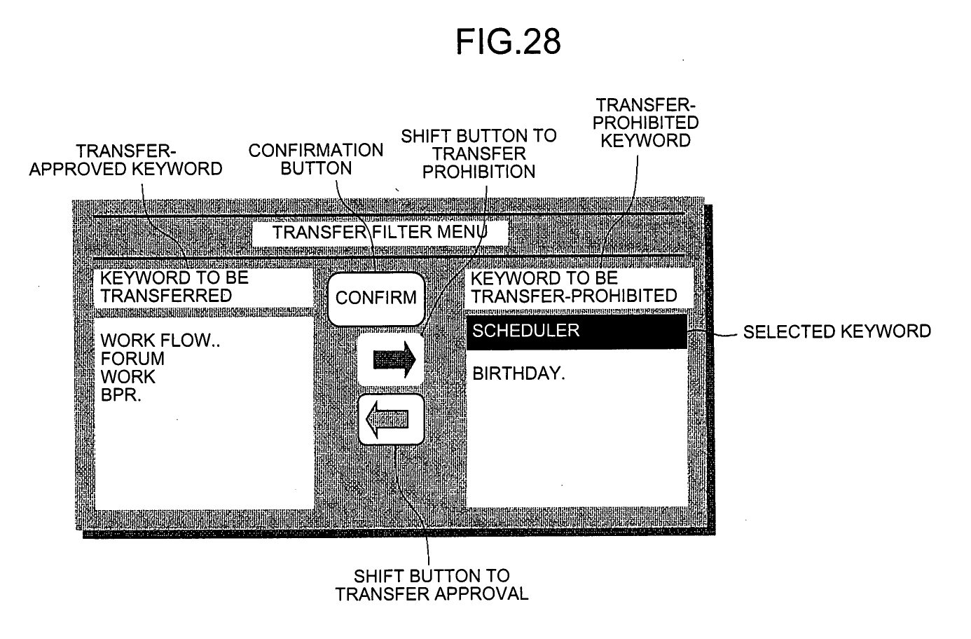

When combining filters in (2) and (1), the word table of (2) is applied to the extracted keywords, to divide the keywords into transfer-approved keywords and transfer-prohibited keywords. For example, the respective lists are displayed in a dialog shown in FIG. 28. When the displayed transfer-approved keywords or transfer-prohibited keywords are not appropriate, the user changes the evaluation. At the time of the change, the user selects a keyword to be changed, and clicks a shift button to transfer approval or to transfer prohibition, to perform shift. If there is no other changes to be made, the user clicks the confirmation button. When the confirmation button clicked, the keyword set to transfer approval or transfer prohibition is registered in the word table to update the word table.

In this case, transfer approval or denial of the keyword, for which transfer approval or denial has been automatically determined, can be finally confirmed, thereby further improving the safety of privacy.

When combining filters in (3) and (1), the document ID table of (3) is applied to the extracted keywords, to divide the keywords into the transfer-approved keywords and the transfer-prohibited keywords. For example, the respective lists are displayed in the dialog shown in FIG. 27. When the displayed transfer-approved keywords or transfer-prohibited keywords are not appropriate, the user changes the evaluation. At the time of the change, the user selects a keyword to be changed, and clicks a shift button to transfer approval or to transfer prohibition, to perform shift. If there is no other changes to be made, the user clicks the confirmation button.

In this case, transfer approval or denial of the keyword, for which transfer approval or denial has been automatically determined, can be finally confirmed, thereby further improving the safety of privacy.

When combining filters in (3), (2), and (1), the keywords extracted from the browsed document and the transfer approval/denial are determined according to the method of (3), the word table of (2) is applied to these keywords, to modify the transfer approval/denial of the keywords, and respective keyword lists are displayed in the dialog, for example, as shown in FIG. 27. If the displayed transfer-approved keywords or transfer-prohibited keywords are not appropriate, the user changes the evaluation. At the time of the change, the user selects a keyword to be changed, and clicks a shift button to transfer approval or to transfer prohibition, to perform shift. If there is no other changes to be made, the user clicks the confirmation button.

In this case, transfer approval or denial of the keyword, for which transfer approval or denial has been automatically determined, can be finally confirmed, thereby further improving the safety of privacy.

According to the present invention, by constituting the transfer filtering unit in the described manner, filtering at various levels can be performed, whereas according to the conventional method of obtaining the URL, whether to obtain the URL can be only selected.

The present invention is not limited to the embodiments described above. It is a matter of course that the object of the present invention can be achieved by programming the respective functions constituting these embodiments and writing the programs on a recording medium beforehand, and installing the recording medium in a computer, storing these programs from the recording medium into a memory or a storage unit in the computer to execute the programs.

In this case, the programs themselves read from the recording medium realize the functions in the embodiments, and hence, these programs and the recording medium storing the programs also constitute the present invention.

The recording medium for storing the programs can be any one of the semiconductor media (for example, read only memory (ROM), non-volatile memory card, and the like), optical media (for example, digital versatile disk (DVD), magneto-optical (MO), magnetic disk (MD), compact disk (CD), and the like), and magnetic media (for example, magnetic tape, flexible disk, and the like).

Furthermore, not only the functions in the embodiments are realized by executing the loaded programs, but also the functions in the embodiments are realized by performing processing in cooperation with the operating system or other application programs based on the command of the program.

When distributing the programs in the market, the programs can be stored in a portable recording medium and distributed, or the programs can be stored in a storage unit of a server computer connected via a communication network such as the Internet, and transferred to other computers through the communication network. In this case, the storage unit of the server computer is also included in the recording medium according to the present invention.

With the computer, the functions of the embodiments are realized by installing the programs on the portable recording medium or the transferred programs on a recording medium connected to the computer, and executing the installed programs.

Thus, by programming the functions of the embodiments and distributing the programs, the accompanying cost can be reduced, and the portability and the generality can be improved.

According to the present invention, since the context information obtained from the browsed document or the history of the browsed document is used in addition to the keyword input by the user, the search result intended by the user can be obtained by using only one input keyword, while maintaining the comfortable conventional operation environment by using a mouse.

Likewise, in the advertising search service, an advertisement more suitable to user's interests can be provided when the user inputs one keyword, while maintaining the comfortable conventional operation environment by using the mouse. Accordingly, the click ratio of the advertising content can be improved.

Furthermore, according to the present invention, since the information provider does not receive the contents of the document browsed by the user, but obtains only the context information related to the document, it is difficult to identify the document browsed by the user, thereby reducing the possibility of violating the user's privacy.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

1. A system for retrieving information, the system comprising:
a first-keyword extracting unit that extracts a character string from a document displayed on a display as a first keyword;
a command-menu displaying unit that displays a command menu for the first keyword on the display;
a second-keyword extracting unit that extracts, when a command for retrieving the information is selected by a user from the command menu, a second keyword from a predetermined part of the document;
an information retrieving unit that retrieves the information based on the first keyword and the second keyword; and
an information displaying unit that displays the information retrieved on the display.

2. The system according to claim 1, further comprising an advertising-contents retrieving unit that retrieves advertising contents based on the first keyword and the second keyword, wherein
the information displaying unit displays the information and the advertising contents retrieved on the display.

3. The system according to claim 1, wherein the first-keyword extracting unit extracts a character string selected by the user when a mouse is operated with a mouse pointer positioned on the character string selected.

4. The system according to claim 3, wherein
the mouse includes a first mouse button, a second mouse button, and a third mouse button,
the first mouse button functions as a left mouse button,
the second mouse button functions as a right mouse button, and
an operation of the mouse includes clicking the third mouse button.

5. The system according to claim 1, wherein
the system includes a server and a client connected via a network,
the server provides an information retrieval service, and
the client requests the information retrieval service to the server, and includes the second-keyword extracting unit and a second-keyword sending unit that sends the second keyword to the server.

6. The system according to claim 1, further comprising comprising:
a keyword storing unit that stores the second keyword and a rank of the second keyword in a database; and
a third-keyword extracting unit that extracts at least one keyword having a highest rank from the database as a third keyword; wherein
the information retrieving unit retrieves the information based on the first keyword and the third keyword.

7. (canceled)

8. The system according to claim 6, wherein the rank is a frequency at which the second keyword is extracted according to the first keyword.

9. (canceled)

10. (canceled)

11. The system according to claim 6, wherein
the system includes a server and a client connected via a network,
the server provides an information retrieval service, and includes the database and the keyword storing unit, and
the client requests the information retrieval service to the server.

12. The system according to claim 6, wherein
the system includes a server and a client connected via a network,
the server provides an information retrieval service, and
the client requests the information retrieval service to the server, and includes the database and the keyword storing unit.

13. (canceled)

14. (canceled)

15. (canceled)

16. (canceled)

17. (canceled)

18. (canceled)

19. A client device connected to a server for retrieving information via a network, the client device comprising:
a first-keyword extracting unit that extracts a character string from a document displayed on a display as a first keyword;
a command-menu displaying unit that displays a command menu for the first keyword on the display;
a second-keyword extracting unit that extracts, when a command for retrieving the information is selected by a user from the command menu, a second keyword from a predetermined part of the document;
a keyword sending unit that sends the first keyword and the second keyword to the server;
an information receiving unit that receives the information retrieved by the server based on the first keyword and the second keyword; and
an information displaying unit that displays the information received on the display.

20. The client device according to claim 19, wherein the information includes advertising contents.

21. The client device according to claim 19 further comprising:
a keyword storing unit that stores the second keyword and a rank of the second keyword in a database; and
a third-keyword extracting unit that extracts at least one keyword having a highest rank from the database as a third keyword; wherein
the keyword sending unit sends the first keyword and the second third keyword to the server; and
the information receiving unit receives the information retrieved by the server based on the first keyword and the third keyword.

22. (canceled)

23. The client device according to claim 21, wherein the rank is a frequency at which the second keyword is extracted according to the first keyword.

24. (canceled)

25. (canceled)

26. A method of retrieving information, the method comprising:
extracting a character string from a document displayed on a display as a first keyword;
displaying a command menu for the first keyword on the display;
extracting, when a command for retrieving the information is selected by a user from the command menu, a second keyword from a predetermined part of the document;
retrieving the information based on the first keyword and the second keyword; and
displaying the information retrieved on the display.

27. The method according to claim 26, further comprising retrieving advertising contents based on the first keyword and the second keyword, wherein
the displaying includes displaying the information and the advertising contents retrieved on the display.

28. The method of according to claim 26, further comprising:
storing the second keyword and a rank of the second keyword in a database; and
extracting at least one keyword having a highest rank from the database as a third keyword; wherein
the retrieving includes retrieving the information based on the first keyword and the third keyword.

29. (canceled)

30. (canceled)

31. (canceled)

32. A computer-readable recording medium that stores therein a computer program for retrieving information, wherein the computer program causes a computer to execute:
extracting a character string from a document displayed on a display as a first keyword;
displaying a command menu for the first keyword on the display;
extracting, when a command for retrieving the information is selected by a user from the command menu, a second keyword from a predetermined part of the document;
retrieving the information based on the first keyword and the second keyword; and
displaying the information retrieved on the display.

33. The computer-readable recording medium according to claim 32, wherein the computer program further causes the computer to execute:
storing the second keyword and a rank of the second keyword in a database; and
extracting at least one keyword having a highest rank from the database as a third keyword; wherein
the retrieving includes retrieving the information based on the first keyword and the third keyword.

34. (canceled)
